(19) United States
(12) Patent Application Publication
(10) Pub. No.: US 2025/0350404 A1
(43) Pub. Date: Nov. 13, 2025

(54) TECHNIQUES FOR PARALLEL BINARY SHAPING

(71) Applicant: QUALCOMM Incorporated, San Diego, CA (US)

(72) Inventors: Eugene BAIK, Sunnyvale, CA (US); Didier Johannes Richard VAN NEE, Tull en 't Waal (NL)

(21) Appl. No.: 18/657,681

(22) Filed: May 7, 2024

(51) Int. Cl. H04L 1/00

(52) U.S. Cl. CPC H04L 1/0066; H04L 1/0003; H04L 1/0042

(57) ABSTRACT

This disclosure provides methods, components, devices and systems for performing probabilistic shaping using parallel binary shaping encoders. In some implementations, a data payload or information bit stream may be shaped or distributed across a set of constellation points using multiple separate binary shaping encoders that run independently and in parallel with one another. In particular, the data payload or information bit stream may be divided up into multiple “parallelized” bit streams that correspond to respective bit positions within the data payload, such as most significant bit (MSB) positions and least significant bit (LSB) positions of the data payload. The parallelized bit streams may be input into respective parallel binary shaping encoders, where the binary shaping encoders each alter the probability or distribution of the value of the respective bit positions to adjust the distribution across the symbols of the modulation constellation.

### TECHNICAL FIELD

This disclosure relates generally to wireless communication and, more specifically, to techniques for parallel binary shaping.

### DESCRIPTION OF THE RELATED TECHNOLOGY

Wireless communication networks may include various types of wireless communication devices including network entities (such as wireless access points (AP) or base stations (BS)), client devices (such as wireless stations (STAs) or user equipment (UEs)), and other wireless nodes. These wireless communication devices may communicate with one another via a variety of technologies and wireless communication protocols, including wireless local area network (WLAN) or Wi-Fi-based protocols or cellular (such as 4G, 5G, or 6G)-based protocols. The wireless communication networks may be capable of supporting communication with multiple users by sharing the available system resources (such as time, frequency, and spatial resources). To enable features or provide improved performance, the wireless communication devices may employ technologies such as orthogonal frequency divisional multiple access (OFDMA), multi-user Multiple-Input Multiple-Output (MU-MIMO), spatial multiplexing, and beamforming. For greater inter-operability, the wireless communication networks may support backwards compatibility (such as supporting legacy wireless communication devices) as well as forward compatibility (such as supporting communication with wireless communication devices compatible with next-generation wireless communication standards).

### SUMMARY

The systems, methods, and devices of this disclosure each have several innovative aspects, no single one of which is solely responsible for the desirable attributes disclosed herein.

One innovative aspect of the subject matter described in this disclosure may be implemented in a method for wireless communications at a first wireless device. The method may include obtaining a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each symbol of a message to be transmitted by the first wireless device includes a first bit position associated with the first parallelized bit stream and a second bit position associated with the second parallelized bit stream, generating the message in accordance with modulating the first shaped bit stream and the second shaped bit stream to a set of symbols of a modulation constellation, and transmitting the message to a second wireless device.

Another innovative aspect of the subject matter described in this disclosure may be implemented in a first wireless device for wireless communications. The first wireless device may include a processing system that includes processor circuitry and memory circuitry that stores code. The processing system may be configured to cause the first wireless device to obtain a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each symbol of a message to be transmitted by the first wireless device includes a first bit position associated with the first parallelized bit stream and a second bit position associated with the second parallelized bit stream, generate the message in accordance with modulating the first shaped bit stream and the second shaped bit stream to a set of symbols of a modulation constellation, and transmit the message to a second wireless device.

Another innovative aspect of the subject matter described in this disclosure may be implemented in first wireless device for wireless communications. The first wireless device may include means for obtaining a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each symbol of a message to be transmitted by the first wireless device includes a first bit position associated with the first parallelized bit stream and a second bit position associated with the second parallelized bit stream, means for generating the message in accordance with modulating the first shaped bit stream and the second shaped bit stream to a set of symbols of a modulation constellation, and means for transmitting the message to a second wireless device.

Another innovative aspect of the subject matter described in this disclosure may be implemented in a non-transitory computer-readable medium storing code for wireless communications. The code may include instructions executable by one or more processors to obtain a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each symbol of a message to be transmitted by the first wireless device includes a first bit position associated with the first parallelized bit stream and a second bit position associated with the second parallelized bit stream, generate the message in accordance with modulating the first shaped bit stream and the second shaped bit stream to a set of symbols of a modulation constellation, and transmit the message to a second wireless device.

In some examples of the method, first wireless devices, and non-transitory computer-readable medium described herein, the first binary shaping operation may be associated with a first bit ratio between the first parallelized bit stream and the first shaped bit stream, the second binary shaping operation may be associated with a second bit ratio between the second parallelized bit stream and the second shaped bit stream, and the first bit ratio and the second bit ratio may be fixed.

Some examples of the method, first wireless devices, and non-transitory computer-readable medium described herein may further include operations, features, means, or instructions for communicating control signaling with the second wireless device, a third wireless device, or both, where the control signaling indicates a modulation and coding scheme (MCS), a spectral efficiency (SE) value, or both, associated with communications between the first wireless device and the second wireless device, where a first shaping rate associated with the first binary shaping operation and a second shaping rate associated with the second binary shaping operation may be selected in accordance with the MCS, the SE value, or both.

Some examples of the method, first wireless devices, and non-transitory computer-readable medium described herein may further include operations, features, means, or instructions for selecting an overall effective shaping rate in accordance with the MCS, the SE value, or both and selecting the first shaping rate for the first binary shaping operation and the second shaping rate for the second binary shaping operation in accordance with the overall effective shaping rate, where the first shaping rate may be greater than or equal to the second shaping rate.

Some examples of the method, first wireless devices, and non-transitory computer-readable medium described herein may further include operations, features, means, or instructions for indexing a data object using the MCS, the SE value, or both, to select the first shaping rate and the second shaping rate.

Another innovative aspect of the subject matter described in this disclosure may be implemented in a method for wireless communications by a second wireless device. The method may include receiving a message from a first wireless device, demodulating the message by mapping a set of symbols of a modulation constellation to at least a first shaped bit stream and a second shaped bit stream, and obtaining a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream.

Another innovative aspect of the subject matter described in this disclosure may be implemented in a second wireless device for wireless communications. The second wireless device may include a processing system that includes processor circuitry and memory circuitry that stores code. The processing system may be configured to cause the second wireless device to receive a message from a first wireless device, demodulate the message by mapping a set of symbols of a modulation constellation to at least a first shaped bit stream and a second shaped bit stream, and obtain a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream.

Another innovative aspect of the subject matter described in this disclosure may be implemented in a second wireless device for wireless communications. The second wireless device may include means for receiving a message from a first wireless device, means for demodulating the message by mapping a set of symbols of a modulation constellation to at least a first shaped bit stream and a second shaped bit stream, and means for obtaining a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream.

Another innovative aspect of the subject matter described in this disclosure may be implemented in a non-transitory computer-readable medium storing code for wireless communications. The code may include instructions executable by one or more processors to receive a message from a first wireless device, demodulate the message by mapping a set of symbols of a modulation constellation to at least a first shaped bit stream and a second shaped bit stream, and obtain a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream.

In some examples of the method, second wireless devices, and non-transitory computer-readable medium described herein, the first binary deshaping operation may be associated with a first bit ratio between the first parallelized bit stream and the first shaped bit stream, the second binary deshaping operation may be associated with a second bit ratio between the second parallelized bit stream and the second shaped bit stream, and the first bit ratio and the second bit ratio may be fixed.

Some examples of the method, second wireless devices, and non-transitory computer-readable medium described herein may further include operations, features, means, or instructions for communicating control signaling with the first wireless device, a third wireless device, or both, where the control signaling indicates an MCS, an SE value, or both, associated with communications between the first wireless device and the second wireless device, where a first shaping rate associated with the first binary deshaping operation and a second shaping rate associated with the second binary deshaping operation may be selected in accordance with the MCS, the SE value, or both.

Some examples of the method, second wireless devices, and non-transitory computer-readable medium described herein may further include operations, features, means, or instructions for selecting an overall effective shaping rate in accordance with the MCS, the SE value, or both and selecting the first shaping rate for the first binary deshaping operation and the second shaping rate for the second binary deshaping operation in accordance with the overall effective shaping rate, where the first shaping rate may be greater than or equal to the second shaping rate.

Details of one or more implementations of the subject matter described in this disclosure are set forth in the accompanying drawings and the description below. Other features, aspects, and advantages will become apparent from the description, the drawings and the claims. Note that the relative dimensions of the following figures may not be drawn to scale.

### BRIEF DESCRIPTION OF THE DRAWINGS

FIG. 1 shows a pictorial diagram of an example wireless communication network.

FIG. 2 shows an example of a transmitter that supports techniques for parallel binary shaping.

FIG. 3 shows an example of a probabilistic shaping configuration that supports techniques for parallel binary shaping.

FIG. 4 shows example data objects that supports techniques for parallel binary shaping.

FIG. 5 shows an example of a binary shaping encoder that supports techniques for parallel binary shaping.

FIG. 6 shows an example of a process flow that supports techniques for parallel binary shaping.

FIG. 7 shows a block diagram of an example wireless communication device that supports techniques for parallel binary shaping.

FIG. 8 shows a block diagram of an example wireless communication device that supports techniques for parallel binary shaping.

FIG. 9 shows a flowchart illustrating an example process performable by or at a first wireless device that supports techniques for parallel binary shaping.

FIG. 10 shows a flowchart illustrating an example process performable by or at a second wireless device that supports techniques for parallel binary shaping.

Like reference numbers and designations in the various drawings indicate like elements.

### DETAILED DESCRIPTION

The following description is directed to some particular examples for the purposes of describing innovative aspects of this disclosure. However, a person having ordinary skill in the art will readily recognize that the teachings herein can be applied in a multitude of different ways. Some or all of the described examples may be implemented in any device, system or network that is capable of transmitting and receiving radio frequency (RF) signals according to one or more of the Institute of Electrical and Electronics Engineers (IEEE) 802.11 standards, the IEEE 802.15 standards, the Bluetooth® standards as defined by the Bluetooth Special Interest Group (SIG), or the Long Term Evolution (LTE), 3G, 4G, 5G (New Radio (NR)) or 6G standards promulgated by the 3rd Generation Partnership Project (3GPP), among others.

The described examples can be implemented in any suitable device, component, system or network that is capable of transmitting and receiving RF signals according to one or more of the following technologies or techniques: code division multiple access (CDMA), time division multiple access (TDMA), orthogonal frequency division multiplexing (OFDM), frequency division multiple access (FDMA), orthogonal FDMA (OFDMA), single-carrier FDMA (SC-FDMA), spatial division multiple access (SDMA), rate-splitting multiple access (RSMA), multi-user shared access (MUSA), single-user (SU) multiple-input multiple-output (MIMO) and multi-user (MU)-MIMO (MU-MIMO). The described examples also can be implemented using other wireless communication protocols or RF signals suitable for use in one or more of a wireless personal area network (WPAN), a wireless local area network (WLAN), a wireless wide area network (WWAN), a wireless metropolitan area network (WMAN), a non-terrestrial network (NTN), or an internet of things (IoT) network.

In some wireless communication networks, wireless devices may utilize modulation schemes which map bits of data to points in a modulation constellation such that each constellation point is used with equal or near-equal probability. Comparatively, other modulation schemes may utilize “probabilistic shaping,” in which bits or modulated symbols are non-uniformly distributed across constellation points of a modulation constellation (such as constellation points are used with uneven probability). However, some probabilistic shaping techniques can be computationally complex and consume relatively large quantities of processing resources. Further, according to some probabilistic shaping techniques, an entire data payload or bit stream may be shaped before the shaped bits can be encoded and packaged into a message for transmission, thereby creating “bottleneck” in the transmission process and leading to increased latency.

Various aspects relate generally to binary shaping techniques. Some aspects more specifically relate to techniques for performing probabilistic shaping using parallel binary shaping encoders. In some implementations, a wireless device may divide up a data payload or information bit stream into multiple “parallelized” bit streams that correspond to respective bit positions within the data payload, such as the most significant bit (MSB) positions and the least significant bit (LSB) positions of the data payload. The wireless device may input these parallelized bit streams into multiple respective parallel binary shaping encoders, and each binary shaping encoders may alter the probability or distribution of the value of the respective bit position from 50% binary “1”s and 50% binary “0”s to some other probability or distribution (such as 90% binary “1”s and 10% binary “0”s, etc.). By altering or shaping the distribution of each respective bit position (as represented by the corresponding parallelized bit stream), the parallel binary shaping encoders may adjust the distribution across the modulation symbols of the modulation constellation. In particular, by using multiple binary shaping encoders in parallel, the wireless device may achieve a monotonically decreasing distribution in which modulation symbols or constellation points relatively closer to the origin of a set of in-phase and quadrature axes are used with a higher frequency, and modulation symbols or constellation points further from the origin of the set of in-phase and quadrature axes are used with a lower frequency.

Particular aspects of the subject matter described in this disclosure can be implemented to realize one or more of the following potential advantages. In some implementations, a wireless device may simplify probabilistic shaping techniques by using multiple parallel binary shaping encoders to reduce processing complexity and reduce latency. In particular, binary shaping encoders may be able to run at some multiple of a modulation symbol rate rather than an input bit rate due to the fact that such binary shaping encoders are used to shape a single bit position, rather than shaping multiple bit positions simultaneously. That is, as compared to some probabilistic shaping techniques in which the entire data payload must be shaped before the shaped bits may be modulated and packaged into a message, binary shaping encoders may shape individual parallelized bit streams iteratively or continuously to generate “shaped” bit streams that are passed downstream for modulation and packaging. As such, the use of parallel binary shaping encoders may remove the “bottleneck” associated with some probabilistic encoders, thereby reducing latency within wireless communications. Additionally, by shaping individual bit positions in parallel with multiple parallel binary shaping encoders, aspects of the present disclosure may be used to achieve a monotonically decreasing distribution across modulation symbols of a modulation constellation, which uses a higher probability for modulation symbols closer to the origin and lower probability for modulation symbols further from the origin. Because modulation symbols closer to the origin are associated with lower transmit power, the monotonically decreasing distribution achieved using parallel binary shaping encoders may reduce the overall power of an encoded message, thereby enabling a transmitting device to increase or scale up the signal for receiver power gain, resulting in improved efficiency and reliability of wireless communications.

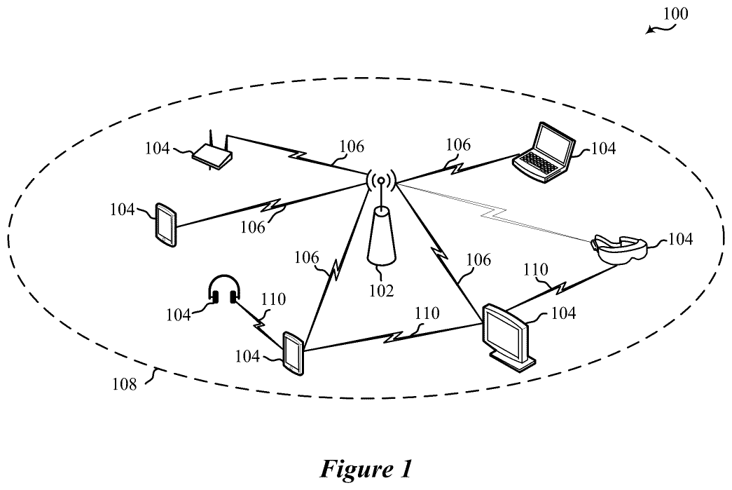

FIG. 1 shows a pictorial diagram of an example wireless communication network 100. According to some aspects, the wireless communication network 100 can be an example of a wireless local area network (WLAN) such as a Wi-Fi network. For example, the wireless communication network 100 can be a network implementing at least one of the IEEE 802.11 family of wireless communication protocol standards, such as defined by the IEEE 802.11-2020 specification or amendments thereof (including, but not limited to, 802.11ay, 802.11ax (also referred to as Wi-Fi 6), 802.11az, 802.11ba, 802.11bc, 802.11bd, 802.11be (also referred to as Wi-Fi 7), 802.11bf, and 802.11bn (also referred to as Wi-Fi 8)) or other WLAN or Wi-Fi standards, such as that associated with the Integrated Millimeter Wave (IMMW) study group. In some other examples, the wireless communication network 100 can be an example of a cellular radio access network (RAN), such as a 5G or 6G RAN that implements one or more cellular protocols such as those specified in one or more 3GPP standards. In some other examples, the wireless communication network 100 can include a WLAN that functions in an interoperable or converged manner with one or more cellular RANs to provide greater or enhanced network coverage to wireless communication devices within the wireless communication network 100 or to enable such devices to connect to a cellular network's core, such as to access the network management capabilities and functionality offered by the cellular network core. In some other examples, the wireless communication network 100 can include a WLAN that functions in an interoperable or converged manner with one or more personal area networks, such as a network implementing Bluetooth or other wireless technologies, to provide greater or enhanced network coverage or to provide or enable other capabilities, functionality, applications or services.

The wireless communication network 100 may include numerous wireless communication devices including a wireless access point (AP) 102 and any number of wireless stations (STAs) 104. While only one AP 102 is shown in FIG. 1, the wireless communication network 100 can include multiple APs 102 (for example, in an extended service set (ESS) deployment, enterprise network or AP mesh network), or may not include any AP at all (for example, in an independent basic service set (IBSS) such as a peer-to-peer (P2P) network or other ad hoc network). The AP 102 can be or represent various different types of network entities including, but not limited to, a home networking AP, an enterprise-level AP, a single-frequency AP, a dual-band simultaneous (DBS) AP, a tri-band simultaneous (TBS) AP, a standalone AP, a non-standalone AP, a software-enabled AP (soft AP), and a multi-link AP (also referred to as an AP multi-link device (MLD)), as well as cellular (such as 3GPP, 4G LTE, 5G or 6G) base stations or other cellular network nodes such as a Node B, an evolved Node B (eNB), a gNB, a transmission reception point (TRP) or another type of device or equipment included in a radio access network (RAN), including Open-RAN (O-RAN) network entities, such as a central unit (CU), a distributed unit (DU) or a radio unit (RU).

Each of the STAs 104 also may be referred to as a mobile station (MS), a mobile device, a mobile handset, a wireless handset, an access terminal (AT), a user equipment (UE), a subscriber station (SS), or a subscriber unit, among other examples. The STAs 104 may represent various devices such as mobile phones, other handheld or wearable communication devices, netbooks, notebook computers, tablet computers, laptops, Chromebooks, augmented reality (AR), virtual reality (VR), mixed reality (MR) or extended reality (XR) wireless headsets or other peripheral devices, wireless earbuds, other wearable devices, display devices (for example, TVs, computer monitors or video gaming consoles), video game controllers, navigation systems, music or other audio or stereo devices, remote control devices, printers, kitchen appliances (including smart refrigerators) or other household appliances, key fobs (for example, for passive keyless entry and start (PKES) systems), Internet of Things (IoT) devices, and vehicles, among other examples.

A single AP 102 and an associated set of STAs 104 may be referred to as an infrastructure basic service set (BSS), which is managed by the respective AP 102. FIG. 1 additionally shows an example coverage area 108 of the AP 102, which may represent a basic service area (BSA) of the wireless communication network 100. The BSS may be identified by STAs 104 and other devices by a service set identifier (SSID), as well as a basic service set identifier (BSSID), which may be a medium access control (MAC) address of the AP 102. The AP 102 may periodically broadcast beacon frames (“beacons”) including the BSSID to enable any STAs 104 within wireless range of the AP 102 to “associate” or re-associate with the AP 102 to establish a respective communication link 106 (hereinafter also referred to as a “Wi-Fi link”), or to maintain a communication link 106, with the AP 102. For example, the beacons can include an identification or indication of a primary channel used by the respective AP 102 as well as a timing synchronization function (TSF) for establishing or maintaining timing synchronization with the AP 102. The AP 102 may provide access to external networks to various STAs 104 in the wireless communication network 100 via respective communication links 106.

To establish a communication link 106 with an AP 102, each of the STAs 104 is configured to perform passive or active scanning operations (“scans”) on frequency channels in one or more frequency bands (for example, the 2.4 GHz, 5 GHZ, 6 GHZ, 45 GHz, or 60 GHz bands). To perform passive scanning, a STA 104 listens for beacons, which are transmitted by respective APs 102 at periodic time intervals referred to as target beacon transmission times (TBTTs). To perform active scanning, a STA 104 generates and sequentially transmits probe requests on each channel to be scanned and listens for probe responses from APs 102. Each STA 104 may identify, determine, ascertain, or select an AP 102 with which to associate in accordance with the scanning information obtained through the passive or active scans, and to perform authentication and association operations to establish a communication link 106 with the selected AP 102. The selected AP 102 assigns an association identifier (AID) to the STA 104 at the culmination of the association operations, which the AP 102 uses to track the STA 104.

As a result of the increasing ubiquity of wireless networks, a STA 104 may have the opportunity to select one of many BSSs within range of the STA 104 or to select among multiple APs 102 that together form an ESS including multiple connected BSSs. For example, the wireless communication network 100 may be connected to a wired or wireless distribution system that may enable multiple APs 102 to be connected in such an ESS. As such, a STA 104 can be covered by more than one AP 102 and can associate with different APs 102 at different times for different transmissions. Additionally, after association with an AP 102, a STA 104 also may periodically scan its surroundings to find a more suitable AP 102 with which to associate. For example, a STA 104 that is moving relative to its associated AP 102 may perform a “roaming” scan to find another AP 102 having more desirable network characteristics such as a greater received signal strength indicator (RSSI) or a reduced traffic load.

In some implementations, STAs 104 may form networks without APs 102 or other equipment other than the STAs 104 themselves. One example of such a network is an ad hoc network (or wireless ad hoc network). Ad hoc networks may alternatively be referred to as mesh networks or P2P networks. In some implementations, ad hoc networks may be implemented within a larger network such as the wireless communication network 100. In such examples, while the STAs 104 may be capable of communicating with each other through the AP 102 using communication links 106, STAs 104 also can communicate directly with each other via direct wireless communication links 110. Additionally, two STAs 104 may communicate via a direct wireless communication link 110 regardless of whether both STAs 104 are associated with and served by the same AP 102. In such an ad hoc system, one or more of the STAs 104 may assume the role filled by the AP 102 in a BSS. Such a STA 104 may be referred to as a group owner (GO) and may coordinate transmissions within the ad hoc network. Examples of direct wireless communication links 110 include Wi-Fi Direct connections, connections established by using a Wi-Fi Tunneled Direct Link Setup (TDLS) link, and other P2P group connections.

In some networks, the AP 102 or the STAs 104, or both, may support applications associated with high throughput or low-latency requirements, or may provide lossless audio to one or more other devices. For example, the AP 102 or the STAs 104 may support applications and use cases associated with ultra-low-latency (ULL), such as ULL gaming, or streaming lossless audio and video to one or more personal audio devices (such as peripheral devices) or AR/VR/MR/XR headset devices. In scenarios in which a user uses two or more peripheral devices, the AP 102 or the STAs 104 may support an extended personal audio network enabling communication with the two or more peripheral devices. Additionally, the AP 102 and STAs 104 may support additional ULL applications such as cloud-based applications (such as VR cloud gaming) that have ULL and high throughput requirements.

As indicated above, in some implementations, the AP 102 and the STAs 104 may function and communicate (via the respective communication links 106) according to one or more of the IEEE 802.11 family of wireless communication protocol standards. These standards define the WLAN radio and baseband protocols for the physical (PHY) and MAC layers. The AP 102 and STAs 104 transmit and receive wireless communications (hereinafter also referred to as “Wi-Fi communications” or “wireless packets”) to and from one another in the form of PHY protocol data units (PPDUs).

Each PPDU is a composite structure that includes a PHY preamble and a payload that is in the form of a PHY service data unit (PSDU). The information provided in the preamble may be used by a receiving device to decode the subsequent data in the PSDU. In instances in which a PPDU is transmitted over a bonded or wideband channel, the preamble fields may be duplicated and transmitted in each of multiple component channels. The PHY preamble may include both a legacy portion (or “legacy preamble”) and a non-legacy portion (or “non-legacy preamble”). The legacy preamble may be used for packet detection, automatic gain control and channel estimation, among other uses. The legacy preamble also may generally be used to maintain compatibility with legacy devices. The format of, coding of, and information provided in the non-legacy portion of the preamble is associated with the particular IEEE 802.11 wireless communication protocol to be used to transmit the payload.

The APs 102 and STAs 104 in the wireless communication network 100 may transmit PPDUs over an unlicensed spectrum, which may be a portion of spectrum that includes frequency bands traditionally used by Wi-Fi technology, such as the 2.4 GHz, 5 GHZ, 6 GHZ, 45 GHz, and 60 GHz bands. Some examples of the APs 102 and STAs 104 described herein also may communicate in other frequency bands that may support licensed or unlicensed communications. For example, the APs 102 or STAs 104, or both, also may be capable of communicating over licensed operating bands, where multiple operators may have respective licenses to operate in the same or overlapping frequency ranges. Such licensed operating bands may map to or be associated with frequency range designations of FR1 (410 MHz-7.125 GHz), FR2 (24.25 GHz-52.6 GHz), FR3 (7.125 GHz-24.25 GHz), FR4a or FR4-1 (52.6 GHz 71 GHz), FR4 (52.6 GHz-114.25 GHz), and FR5 (114.25 GHz-300 GHz).

Each of the frequency bands may include multiple sub-bands and frequency channels (also referred to as subchannels). The terms “channel” and “subchannel” may be used interchangeably herein, as each may refer to a portion of frequency spectrum within a frequency band (for example, a 20 MHz, 40 MHz, 80 MHz, or 160 MHz portion of frequency spectrum) via which communication between two or more wireless communication devices can occur. For example, PPDUs conforming to the IEEE 802.11n, 802.11ac, 802.11ax, 802.11be and 802.11bn standard amendments may be transmitted over one or more of the 2.4 GHz, 5 GHZ, or 6 GHz bands, each of which is divided into multiple 20 MHz channels. As such, these PPDUs are transmitted over a physical channel having a minimum bandwidth of 20 MHz, but larger channels can be formed through channel bonding. For example, PPDUs may be transmitted over physical channels having bandwidths of 40 MHz, 80 MHz, 160 MHz, 240 MHz, 320 MHZ, 480 MHz, or 640 MHz by bonding together multiple 20 MHz channels.

An AP 102 may determine or select an operating or operational bandwidth for the STAs 104 in its BSS and select a range of channels within a band to provide that operating bandwidth. For example, the AP 102 may select sixteen 20 MHz channels that collectively span an operating bandwidth of 320 MHz. Within the operating bandwidth, the AP 102 may typically select a single primary 20 MHz channel on which the AP 102 and the STAs 104 in its BSS monitor for contention-based access schemes. In some implementations, the AP 102 or the STAs 104 may be capable of monitoring only a single primary 20 MHz channel for packet detection (for example, for detecting preambles of PPDUs). Conventionally, any transmission by an AP 102 or a STA 104 within a BSS must involve transmission on the primary 20 MHz channel. As such, in conventional systems, the transmitting device must contend on and win a TXOP on the primary channel to transmit anything at all. However, some APs 102 and STAs 104 supporting ultra-high reliability (UHR) communications or communication according to the IEEE 802.11bn standard amendment can be configured to operate, monitor, contend and communicate using multiple primary 20 MHz channels. Such monitoring of multiple primary 20 MHz channels may be sequential such that responsive to determining, ascertaining or detecting that a first primary 20 MHz channel is not available, a wireless communication device may switch to monitoring and contending using a second primary 20 MHz channel. Additionally, or alternatively, a wireless communication device may be configured to monitor multiple primary 20 MHz channels in parallel. In some implementations, a first primary 20 MHz channel may be referred to as a main primary (M-Primary) channel and one or more additional, second primary channels may each be referred to as an opportunistic primary (O-Primary) channel. For example, if a wireless communication device measures, identifies, ascertains, detects, or otherwise determines that the M-Primary channel is busy or occupied (such as due to an overlapping BSS (OBSS) transmission), the wireless communication device may switch to monitoring and contending on an O-Primary channel. In some implementations, the M-Primary channel may be used for beaconing and serving legacy client devices and an O-Primary channel may be specifically used by non-legacy (for example, UHR-or IEEE 802.11bn-compatible) devices for opportunistic access to spectrum that may be otherwise under-utilized.

Transmitting and receiving devices AP 102 and STA 104 may support the use of various modulation and coding schemes (MCSs) to transmit and receive data in the wireless communication network 100 so as to optimally take advantage of wireless channel conditions, for example, to increase throughput, reduce latency, or enforce various quality of service (QOS) parameters. For example, existing technology (such as IEEE 802.11ax standard amendment protocols) supports the use of up to 1024-QAM, where a modulated symbol carries 10 bits. To further improve peak data rate, each of the AP 102 or the STA 104 may employ use of 4096-QAM (also referred to as “4 k QAM”), which enables a modulated symbol to carry 12 bits. 4k QAM may enable massive peak throughput with a maximum theoretical PHY rate of 10 bps/Hz/subcarrier/spatial stream, which translates to 23 Gbps with 5/6 LDPC code (10 bps/Hz/subcarrier/spatial stream*996*4 subcarriers*8 spatial streams/13.6 us per OFDM symbol). The AP 102 or the STA 104 using 4096-QAM may enable a 20% increase in data rate compared to 1024-QAM given the same coding rate, thereby allowing users to obtain higher transmission efficiency.

Some processes, methods, operations, techniques or other aspects described herein may be implemented, at least in part, using an artificial intelligence (AI) program, such as a program that includes a machine learning (ML) or artificial neural network (ANN) model, hereinafter referred to generally as an AI/ML model. One or more AI/ML models may be implemented in wireless communication devices (for example, APs 102 and STAs 104) and to enhance various aspects associated with wireless communication. For example, an AI/ML model may be trained to identify patterns or relationships in data observed in a wireless communication network 100. An AI/ML model may support operational decisions relating to aspects associated with wireless communications networks or services. For example, an AI/ML model may be utilized for supporting or improving aspects such as reducing signaling overhead (such as by CSI feedback compression, etc.), enhancing roaming or other mobility operations, multi-AP coordination, and generally facilitating network management or optimizing network connections or characteristics to, for example, increase throughput or capacity, reduce latency or otherwise enhance user experience.

An example AI/ML model may include mathematical representations or define computing capabilities for making inferences from input data based on patterns or relationships identified in the input data. As used herein, the term “inferences” can include one or more of decisions, predictions, determinations, or values, which may represent outputs of the AI/ML model. The computing capabilities may be defined in terms of certain parameters of the AI/ML model, such as weights and biases. Weights may indicate relationships between certain input data and certain outputs of the AI/ML model, and biases are offsets that may indicate a starting point for outputs of the AI/ML model. An example AI/ML model operating on input data may start at an initial output based on the biases and then update the output based on a combination of the input data and the weights.

STAs or APs (for example, a STA 104 or an AP 102) may exchange local observations with other wireless communication devices (such as other STAs or APs) or provide feedback related to the communication. This may significantly expand the types of input data that can be considered as input to an AI/ML model, as such information may not otherwise be available at the other wireless communication devices. For example, information received from other STAs or APs may include observed RSSI values, experienced packet success/failure/retry rates per client/AP, BSS/Quality of Service (QOS) load/requirements, or a history of bad/good AP link(s), which may be conveyed in terms of scores or rankings.

AI/ML models can be centralized, distributed, or federated. As both STAs 104 and APs 102 can participate in AI/ML based operations, efficient AI/ML model distribution may enhance the performance of a wireless communication system. In some examples supporting centralized AI/ML models, STAs 104 may provide training data to a centralized network location (such as an AP, AP MLD, or a server) where a global AI/ML model may be generated and refined. The centralized network location may distribute the global AI/ML model to various STAs. In some implementations, global AI/ML models may train a single classifier based on all training data received from various inputs/sources. In some examples supporting distributed learning or distributed models, both APs and STAs may be independently capable of computing AI/ML models and sharing data with other participating wireless communication devices in the wireless communication network such that each device can train the global AI/ML model locally. In some examples supporting a federated learning or hybrid AI/ML model, substantially all participating wireless communication devices (such as APs 102 and STAs 104) may be capable of generating local AI/ML models and sharing their local models to a centralized network location or entity. In turn, the centralized network entity may generate a global AI/ML model using the received local models as input and distribute the global model to all or a subset of the participating wireless communication devices.

In some implementations, AI/ML models may be downloadable. For example, an AP may share AI/ML model components with associated STAs or other friendly/coordinating APs. STAs may download the AI/ML model and use the model for making decisions related to wireless communications. The downloading of an AI/ML model may be independent from signaling the inputs to the AI/ML model (for example, some wireless communication devices may download the AI/ML model without exchanging information with other wireless communication devices; some wireless communication devices may exchange information and use such information as an input to the AI/ML model without downloading it; and some wireless communication devices may download the AI/ML model and exchange information or the AI/ML model with other wireless communication devices).

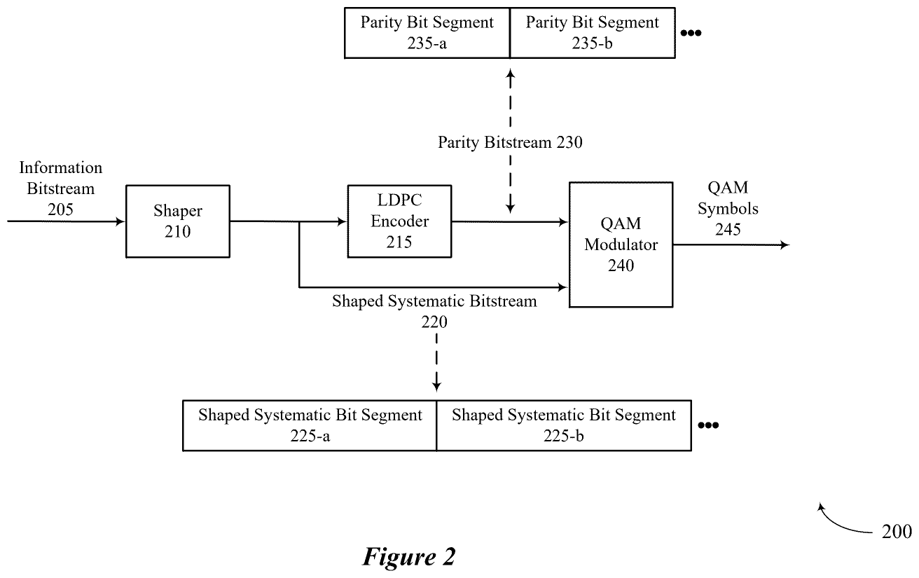

FIG. 2 shows an example of a transmitter 200 that supports techniques for parallel binary shaping. According to some aspects, the transmitter 200 may be part of a WLAN such as a Wi-Fi network (such as system). For example, the transmitter 200 may support at least one of the IEEE 802.11 family of wireless communication protocol standards (such as defined by the IEEE 802.11-2020 specification or amendments thereof including, but not limited to, 802.11ay, 802.11ax, 802.11az, 802.11ba, 802.11bc, 802.11bd, 802.11be, 802.11bf, and 802.11bn).

In some wireless communications systems, such as the Wi-Fi network, wireless devices (such as transmitters 200 and receivers), such as APs 102 and STAs 104, may support the use of various MCSs to transmit and receive data so as to optimally take advantage of wireless channel conditions, for example, to increase throughput, reduce latency, or enforce various QoS parameters. For example, existing technology (such as IEEE 802.11ax standard amendment protocols) supports the use of QAM in which a bit stream may be input into a QAM modulator 240 to form QAM symbols 245, which may be mapped to subcarriers of one or more orthogonal frequency-division OFDM symbol for transmission (such as using a single spatial stream, Nₛₛ=1).

In such implementations (such as Nₛₛ=1), an encoder, such as an LDPC encoder 215, of a transmitting wireless device may receive an information bit stream 205, may generate a systematic bit stream correspond to the information bit stream 205, and may encode (and rate match) the information bit stream 205 to generate a parity bit stream 230 (such as repetition bits), where the parity bit stream 230 is based on the information bit stream 205. A serializer (such as of the transmitting wireless device) at an output of the LDPC encoder 215 may receive the systematic bit stream, and the parity bit stream 230 and may construct one or more LDPC codewords (such as codeword grouping), where each LDPC codeword includes a group of systematic bits (such as from the systematic bit stream), which may be referred to as a systematic bit segment, appended with a group of parity bits (such as from the parity bit stream 230), which may be referred to as a parity bit segment 235. In such implementations, the one or more LDPC codewords may form a single, serialized bit stream to be fed to a single QAM modulator 240. Thus, for a single spatial stream (such as Nₛₛ=1), the single QAM modulator 240 (such as of the transmitting wireless device) may receive the serialized bit stream and may generate one or more QAM symbols 245 based on the received serialized bit stream.

To generate one or more QAM symbols 245, the QAM modulator 240 may map incremental groups of bits (such as systematic bits, parity bits, or both) from the serialized bit stream to constellation points (such as modulation symbols) of a constellation associated with the QAM modulator 240, where each constellation point represents a QAM symbol 245. That is, the QAM modulator 240 may use a specific MCS for generation of the one or more QAM symbols 245, where the MCS defines at least one of the constellation, the modulation order of the one or more QAM symbols, and a size of the group of bits (such as group sizing). In such implementations, the constellation may be associated with a uniform distribution. In other words, values (such as 0 or 1) of each bit of the serialized bit stream may be equally likely, such that each constellation point of the constellation may be associated with an equal (such as same) usage frequency (such as probability or likelihood of use). However, different constellation points may be associated with different energy and average power (such as for transmission). That is, the constellation points may be arranged on a grid defined by an in-phase axis (shown in FIG. 2 as a horizontal axis), also referred to as an I component, and a quadrature axis (shown in FIG. 2 as a vertical axis), also referred to as a Q component, where constellation points located further from an origin (such as intersection of the I axis and Q axis) are associated with a higher energy than constellation points located closer to the origin. Thus, some signals may be generated based on a set of constellation points that are located further from the origin, resulting in high average power.

Accordingly, in some implementations, the transmitting wireless device may perform constellation shaping on the information bit stream 205, such that the constellation (such as associated with the QAM modulator 240) may be associated with a non-uniform distribution in which constellation points of the constellation are associated with variable usage frequencies. In such implementations, the variable usage frequencies may result in constellation points closer to the origin being associated with a higher usage frequency than those located further from the origin. Such as non-uniform distribution may result in a Gaussian distribution of energy associated with a signal (such as generated based on QAM symbols 245 output from the QAM modulator 240), which may enable the signal to attain a threshold (such as maximum entropy, or ability to carry information), while remaining within a threshold (such as maximum) average power consumption associated with the transmitting wireless device.

To support constellation shaping, the transmitting wireless device may include a shaper 210 prior to the LDPC encoder 215 to shape the information bit stream 205 into a shaped systematic bit stream 220 (such as corresponding to the information bit stream 205), such that values (such as 0 or 1) of each bit of the shaped systematic bit stream 220 may not be equally likely (such as may be associated with a non-uniform distribution) which may result in a non-uniform distribution of a constellation associated with the QAM modulator 240. In such implementations, the non-uniform distribution may be based on a structure of the shaped systematic bit stream 220 (such as the structure of the shaped systematic bits in the shaped systematic bit stream 220 may be based on the shaping). According to existing transmitting wireless devices, as described previously, the transmitting wireless device may encode the shaped systematic bit stream 220 to generate a parity bit stream 230, where the parity bit stream 230 is based on the shaped systematic bit stream 220. The serializer at the output of the LDPC encoder 215 may receive the shaped systematic bit stream 230 and the parity bit stream 230 and may construct a serialized bit stream of one or more LDPC codewords, where each LDPC codeword includes a shaped systematic bit segment 225 appended with a parity bit segment 235. Thus, the QAM modulator 240 may receive the serialized bit stream output by the serializer and may generate one or more QAM symbols 245 based on the serialized bit stream.

However, generating one or more QAM symbols 245 based on the single serialized bit stream may negate the shaping performed by the shaper 210. That is, the QAM modulator 240 receiving shaped systematic bits as part of the single serialized bit stream may result in the QAM modulator 240 not accounting for the structure of shaped systematic bits. The structure of the shaped systematic bits may be what enables the non-uniform distribution of the constellation associated with the QAM modulator 240, such that not accounting for the structure may result in the non-uniform distribution not occurring. In other words, mapping the bits of the single serialized bit stream to constellation points may result in an unintended non-uniform distribution that may not achieve a Gaussian distribution of energy.

Accordingly, techniques described herein may enable a transmitting wireless device, such as the transmitter 200, to support constellation shaping. In particular, the transmitter 200 may support constellation shaping for a single spatial stream (such as Nₛₛ=1). For example, a shaper 210 may receive an information bit stream 205 (such as set of information bits) and may shape (such as alter) bits of the information bit stream 205 such that, by the end of a QAM modulation process (such as at a QAM modulator 240), a frequency usage of constellation points (such as of a given QAM modulation order associated with the QAM modulator 240) may be probabilistically shaped to be non-uniform (such as be associated with a non-uniform distribution). Thus, the shaper 210 may output a shaped systematic bit stream 220 (such as including a set of shaped systematic bits) associated with a given structure (such as based on the shaping), where the shaped systematic bit stream 220 corresponds to the information bit stream 205. In such implementations, the structure may be generated such that shaped systematic bits of the shaped systematic bit stream 220 may not be altered and the shaped systematic bit stream 220 may not be segmented or broken up.

An LDPC encoder 215 (such as a rate matcher) may receive the shaped systematic bit stream 220 from the shaper 210 and may generate a parity bit stream 230 (such as repetition bits) based on the shaped systematic bit stream 220. In some implementations, the parity bit stream 230 may include one or more parity bit segments 235 and the shaped systematic bit stream 220 may include one or more shaped systematic bit segments 225, where a combination of a parity bit segment 235 and a shaped systematic bit segment 225 forms an LDPC codeword. For example, a first LDPC codeword may include a parity bit segment 235-a and a shaped systematic bit segment 225-a and a second LDPC codeword may include a parity bit segment 235-b and a shaped systematic bit segment 225-b. Thus, the one or more parity bit segments 235 and the one or more shaped systematic bit segments 225 may form up to N (such as one or more) LDPC codewords. As a systematic encoder, the LDPC encoder 215 may not change the shaped input amplitude bits into the LDPC encoder 215, and may add the parity bit stream 230 to the shaped input amplitude bits. That is, the systematic bits of the LDPC encoder 215 may represent shaped amplitudes, and may not be altered by the LDPC encoder 215 so the final QAM symbols maintain the shaped properties.

As such, the QAM modulator 240 may receive the parity bit stream 230 (such as repetition bits) as a first stream of bits and the shaped systematic bit stream 230 as a second stream of bits. In other words, the QAM modulator 240 may receive two separate inputs (rather than one serially concatenated input). Receiving the shaped systematic bit stream 230 as a separate stream of bits may enable the QAM modulator 240 to maintain the structure of the shaped systematic bit stream 230, which may result in the frequency usage of the constellation points (such as of the given QAM modulation order associated with the QAM modulator 240) to be probabilistically shaped to be non-uniform.

Thus, the QAM modulator 240 may output one or more QAM symbols 245 and the transmitter 200 (such as or another component of the transmitter 200) may map the one or more QAM symbols 245 to one or more subcarriers of one or more OFDM symbols to be transmitted by the transmitter 200. The transmitter 200 may transmit a signal associated with the one or more QAM symbols 245, where the signal is associated with a Gaussian distribution of energy based on the non-uniform probabilistically shaping of the constellation points at the QAM modulator 240.

Some previous probabilistic shaping mechanisms may suffer from several drawbacks. For example, some previous probabilistic shaping schemes may use a single coder per I/Q rail to encode output PAM symbols based on binary input. However, such PAM encoders may be quite complex and may be computationally expensive. Further, in some probabilistic shaping techniques, the shaper 210 may be required to run at the input bit rate, which may be very large in WLAN. That is, in accordance with some shaping techniques, the shaper 210 may be required or otherwise expected to shape all bits of a message (such as shape all the bits of the information bit stream 205) before the shaped bits may be input into the encoder 215. As such, some conventional probabilistic shaping mechanisms create a “bottleneck” within the flow illustrated in FIG. 2, which may increase latency of wireless communications.

Accordingly, some aspects of the present disclosure are directed to probabilistic shaping techniques that split the shaping performed by the shaper 210 into multiple binary coders. That is, instead of using a single probabilistic shaper or encoder to shape all the bits of the information bit stream 205 at once, aspects of the present disclosure are directed to techniques to utilizing multiple binary shaping encoders to shape multiple parallelized bit streams of the information bit stream 205 in parallel (such as simultaneously), where the multiple binary shaping encoders perform shaping independently of one another. In this regard, aspects of the present disclosure are directed to probabilistic shaping techniques that use separate binary shaping encoders per amplitude bit, rather than using one PAM shaping coder as is used by some previous shaping techniques. In such implementations, the parallel binary shaping coders may run at a modulation symbol rate (such as a PAM symbol rate) of the information bit stream 205, rather than at the input bit rate.

In some aspects, a binary coding step (such as shaper 210) before the LDPC encoder may introduce a small amount of redundancy to ensure that I/Q constellations are close to Gaussian, rather than uniform. Using the binary shaping techniques may enable the average constellation power to be significantly smaller for shaped QAM. Further, these binary shaping techniques may be used to redistribute the probability of constellation point usage to use higher signal scaling at the transmitter (Tx) device, where the resulting power gains of the received signals outweigh the rate loss introduced by the shaping, resulting in a net gain.

Accordingly, aspects of the present disclosure are directed to techniques for using multiple binary shaping encoders as basic building blocks for amplitude shaping. At a high level, binary shaping encoders operate by receiving a set of input bits and applying a mapping such that the resulting output bits has the desired probability distribution (p) of “0”s and “1”s. In other words, binary shaping encoders may change a probability distribution from p=0.5 (such as 50% “1”s and 50% “0”s) to some other probability distribution, such as p=0.7 (such as 70% “1”s and 30% “0”'s, etc.).

The mapping performed by binary shaping encoders may be entirely reversible, without loss, so that the shaping performed by a Tx device may be effectively reversed or undone by a receiving (Rx) device. Binary shapers may further introduce redundancy to achieve the desired probability distribution. Such binary shaping encoders may not be a FEC and may have no impact on the effectiveness of the LDPC encoder 215. Further, altering the probability distributions of an information bit stream 205 (such as altering a priori p (b=0 or 1)) may have no noticeable impact on a slicer or MIMO detector.

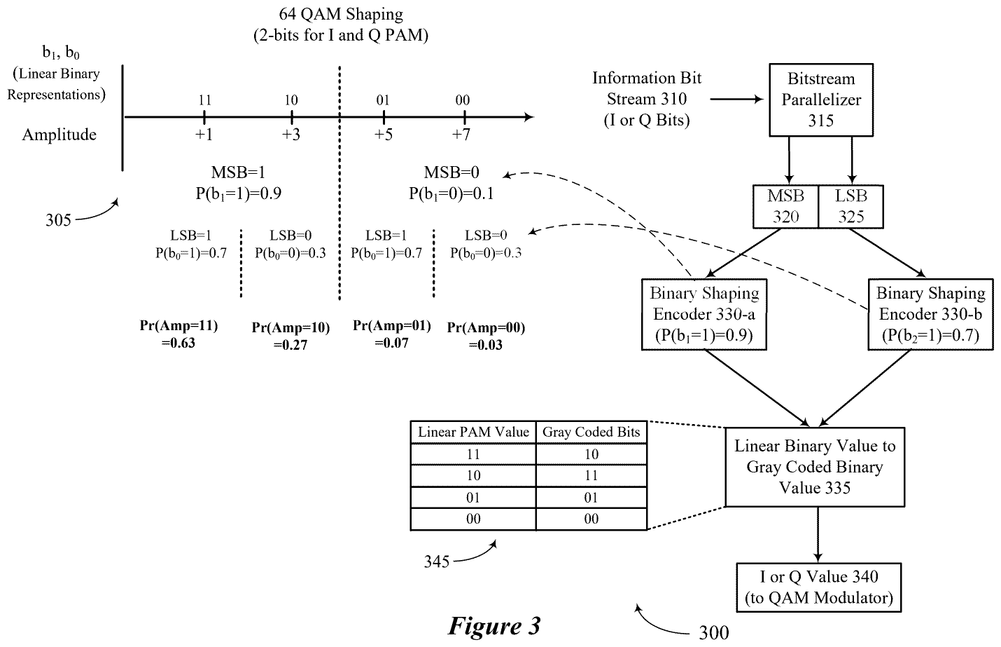

FIG. 3 shows an example of a probabilistic shaping configuration 300 that supports techniques for parallel binary shaping. Aspects of the probabilistic shaping configuration 300 may implement, or be implemented by, aspects of the wireless communication network 100, the transmitter 200, or both. In particular, the probabilistic shaping configuration 300 may include an example of a parallel binary shaping operation performed by the shaper 210 shown and described in FIG. 2.

As noted previously, aspects of the present disclosure are directed to probabilistic shaping techniques that use separate binary shaping encoders per amplitude bit, rather than using one PAM shaping coder as is used by some previous shaping techniques. In such implementations, the parallel binary shaping coders may run at a modulation symbol rate (such as PAM symbol rate) of the information bit stream 205, rather than at the input bit rate.

In some aspects, for a given QAM order, a Tx device may utilize some quantity of binary shaping encoders for amplitude bit positions for each of the I and Q rails (such as each of the I and Q rails will utilize one or more separate binary shaping encoders). All or some subset of the amplitude bit positions may be shaped. For example, 256 QAM may include eight total bits per modulation symbol, four total I bits and four total Q bits per modulation symbol. The four I bits and four Q bits may each include one sign bit and three amplitude bits. In some implementations, all three I amplitude bits and all three Q amplitude bits may be shaped for a total of six shaping encoders running in parallel (such as three binary shaping encoders for shaping the three I amplitude bits, and three binary shaping encoders for shaping the three Q amplitude bits). In some cases, the target shaping characteristics of the I and Q rail PAM symbols (which form the full QAM symbol) may be the same, in which case the Tx device may select to have the I amplitude bits and the Q amplitude bits share the same set of shapers, and assign that single set to produce shaped amplitudes of both I and Q. Specifically, in the context of 256 QAM, a Tx device may select to run three binary shapers with double the original number of input bits, and at twice the hardware rate, to produce double the original number of shaped PAM symbol amplitudes, which at a later stage can be designated for I or Q rails to produce the original number of QAM symbol amplitudes. Such an approach can be desirable and considered an appropriate implementation tradeoff from a hardware efficiency perspective.

By way of another example, 4096 QAM may include twelve total bits per modulation symbol (six I bits and six Q bits). In this example, a wireless device may be configured to shape only the three MSB positions of each I and Q amplitude, and leave two LSB positions of each I and Q bit unshaped, for a total of six shaping encoders running in parallel (such as three binary shaping encoders for shaping the three I amplitude MSBs, and three binary shaping encoders for shaping the three Q amplitude MSBs). In such implementations, the performance loss of leaving some bit positions unshaped (such as two unshaped I LSBs and two unshaped Q LSBs) may be relatively small. Further, in each of these examples, the sign bit positions for I and Q may receive parity bits as part of the LDPC encoding process. In some implementations, the I and Q amplitudes can share the same set of shapers (and be designed to produce twice the original number of total shaped amplitudes) if they have the same target shaping characteristics.

In some aspects, the output coding length for parallel binary shaping operations may be fixed. In other words, as compared to variable length shaping that is used by some conventional shaping techniques, the probabilistic shaping techniques may utilize a known, deterministic relationship (such as known ratio) between the number of input and output bits of the shaping encoders. Using a known, deterministic relationship or ratio between input and output bits may eliminate various challenges in constellation shaping, such as unknown PPDU duration, error propagation at the receiver, and the like. Further, it has been found that the parallel binary shaping techniques may exhibit relatively small rate loss from theoretical upper bounds, depending on a respective fixed-point design in hardware implementation.

The probabilistic shaping configuration 300 illustrates an example for shaping an information bit stream 310 for 64 QAM, which may include six total bits per modulation symbol, three total bits for I PAM and three total bits for Q PAM. The three I bits and three Q bits may each include one sign bit and two amplitude bits. As such, each I PAM symbol and each Q PAM symbol may be denoted by {b₂, b₁, b₀}, where b₂ is the sign bit and b₁ and b₂ are the amplitude bits. For the amplitude bits, b₁ may be referred to as the MSB, and b₂ may be referred to as the LSB. For instance, the graph 305 illustrates linear binary representations of the amplitude bit positions (b₁, b₀) of 64 QAM symbols. That is, binary representation “10” refers to b₁ (MSB)=1 and b. (LSB)=0.

A transmitting device may receive or otherwise identify an information bit stream 310 that is to be transmitted to a receiving device. The transmitting device may input the information bit stream 310 into a bit stream parallelizer 315 to generate multiple parallelized bit streams. Each parallelized bit stream may correspond to a bit position for each modulation symbol in the message transmitted by the device. For example, the bit stream parallelizer 315 may generate an MSB bit stream 320 corresponding to the MSB bit position (such as b₁ parallelized bit stream) and an LSB bit stream 325 corresponding to the LSB bit position (such as b₀ parallelized bit stream).

The MSB bit stream 320 may be input into a first binary shaping encoder 330-a, and the LSB bit stream 325 may be input into a second binary shaping encoder 330-b. In some aspects, the first binary shaping encoder 330-a and the second binary shaping encoder 330-b may run in parallel (such as simultaneously) to shape the respective MSB bit stream 320 and the LSB bit stream 325. Further, the first binary shaping encoder 330-a and the second binary shaping encoder 330-b may run independently of one another.

For instance, as shown in FIG. 3, the first binary shaping encoder 330-a may utilize a target distribution probability of 0.9 (such as P(b₁=1)=0.9). That is, the first binary shaping encoder 330-a may shape the MSB bit stream 320 so that 90% of the MSB bit position is equal to 1 (and 10% of the MSB bit position is equal to 0). Similarly, the second binary shaping encoder 330-b may utilize a target distribution probability of 0.7 (such as P(b₀=1)=0.7). That is, the second binary shaping encoder 330-b may shape the LSB bit stream 325 so that 70% of the LSB bit position is equal to 1 (and 30% of the LSB bit position is equal to 0).

In some aspects, for the parallel binary shaping techniques of the present disclosure to produce desirable QAM distributions, the probability distributions P across bit positions (such as from MSBs to LSBs) may decrease. That is, the probability distribution of the first binary shaping encoder 330-a (P=0.9) is greater than the probability distribution of the second binary shaping encoder 330-b (P=0.7). Further, in implementations where the probabilistic shaping configuration 300 includes additional parallelized bit streams and additional binary shaping encoders 330, the probability distribution of the second binary shaping encoder 330-b (P=0.7) would be greater than the probability distribution of a third binary shaping encoder 330, and the like.

The parallel binary shaping encoders 330 may be used to adjust the probability of the respective constellation points in the graph 305. For example, without any shaping, each of the constellation points 11, 10, 01, and 00 in the graph 305 may be used with equal probability (such as 25% each). Comparatively, the parallel binary shaping encoders 330 may be used in parallel to adjust the probability of the respective constellation points. In particular, the parallel binary shaping encoders 330 may be used to adjust or “bias” the probability toward the constellation points closer to the origin (in order to reduce the Tx power).

For example, the first binary shaping encoder 330-a uses a distribution probability (such as shaping rate) of P=0.9 to bias the MSB bit position toward 90% binary “1” s. In other words, the first binary shaping encoder 330-a biases the MSB bit stream 320 toward 11 and 10 (where MSB (b₁)=1). Similarly, the second binary shaping encoder 330-b uses a distribution probability (such as shaping rate) of P=0.7 to bias the MSB bit position toward 70% binary “1”s. In other words, the second binary shaping encoder 330-b biases the LSB bit stream 325 toward 11 and 01 (where LSB (b₀)=1). Taken together, the parallel binary shaping encoders 330 may result in distribution probabilities of the respective constellation points of 0.63, 0.27, 0.07, and 0.03. As such, the parallel binary shaping encoders 330 may be used to achieve monotonically decreasing distribution probabilities, where constellation points closer to the origin (such as 11) are used with higher probabilities as compared to constellation points further from the origin (such as 00).

Continuing with reference to the probabilistic shaping configuration 300, the linear binary values may be converted to Gray coded binary values at 335. Gray coded binary values are a mapping between bit sequences and constellation points where only one bit of a sequence is to change when mapping from point to point (such as 01, 00, 10, 11). As such, converting from the linear binary values to the Gray coded values (where only one value changes from one point to the next) may reduce bit errors for communicated messages. For example, the table 345 illustrates mappings from the linear binary values (such as linear PAM values) shown in the graph 305 to corresponding Gray coded values or bits. After conversion, the probabilistic shaping configuration 300 selects or determines the I or Q values at block 340 for the respective bit positions that will be sent to the QAM modulator for generating a message that encodes the information of the information bit stream 310. In some aspects, the linear binary values may be converted to Gray coded binary values due to the fact that QAM constellations are defined as Gray coded values in one or more of the IEEE 802.11 family of wireless communication protocol standards. As such, the Tx device may shape the bit position streams assuming linear sequencing of binary representations for amplitudes to ensure the amplitudes usage frequencies monotonically decrease. In some implementations, for the shaped bitstream to map to the desired QAM symbols that the binary shaping encoders 330 shape towards, the Gray coding conversion at 335 may be performed because the bits-to-QAM symbol modulator/mapper procedure at the Tx device and the QAM-to-bits demodulator/de-mapper procedure at the Rx device (as defined in one or more of the IEEE 802.11 family of wireless communication protocol standards) are Gray coded by definition.

In some aspects, the different target distribution probabilities (such as shaping rates) of the respective binary shaping encoders 330 may be selected to achieve some overall effective distribution or shaping rate (such as Gaussian distribution). Further, the overall effective probability distribution or shaping rate may be based on characteristics of the wireless communications to be performed, such as MCS and spectral efficiency (SE). For example, the IEEE 802.11 specification (such as 802.11n, 802.11ac, 802.11ax, 802.11be, and the like) defines an MCS table of LDPC rate and QAM order combinations that are to be used to achieve various SEs within a set range.

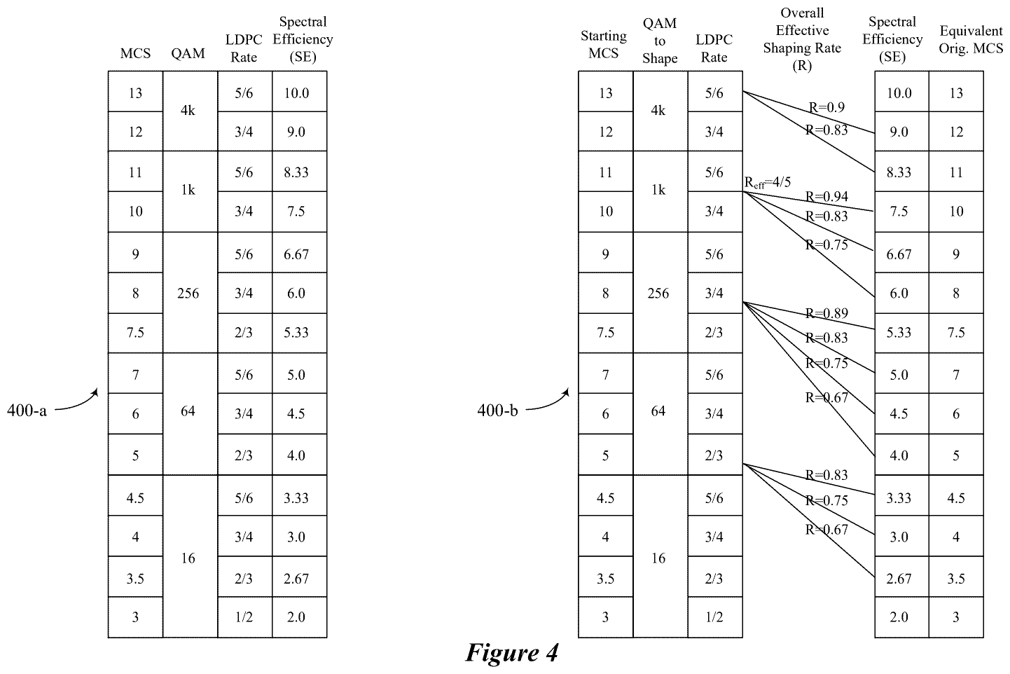

FIG. 4 shows example data objects 400-a, 400-b that supports techniques for parallel binary shaping. Aspects of the data objects 400-a, 400-b may implement, or be implemented by, the wireless communication network 100, the transmitter 200, the probabilistic shaping configuration 300, or any combination thereof.

The data object 400-a (shown as a table in FIG. 4) is an example of an MCS table of LDPC rate and QAM order combinations that are to be used to achieve various SEs within a set range. When shaping is used, the effective SE is the nominal SE (selected by the LDPC Rate and QAM order) scaled by the shaping rate. In other words, the SE may be calculated by multiplying the QAM order by the LDPC rate. For example, 256 QAM includes 8 bits per modulation symbol. As such, for 256 QAM, the SE is calculated by multiplying the LDPC rate by 8 (such as 8*3/4=6.0).

In some aspects, the parallel bit shaping techniques of the present disclosure may act on information bits prior to the LDPC encoding and QAM modulation. Due to the fact that shaping (including parallel bit shaping) introduces some redundancy to alter bit distributions, the overall shaping rate may be less than 1.0. For example, the second data object 400-b illustrated in FIG. 4 illustrates overall effective shaping rates (R) of shaping encoders, and how such shaping rates affect the SE. For instance, parallel binary shaping with a shaping rate of 0.89 used for 256 QAM with an LDPC rate of 3/4 would result in an SE of 5.33, as compared to SE of 6.0 in data object 400-a (such as 8*3/4*0.89=5.33). Thus, by comparing the rows of the first data object 400-a with the rows of the second data object 400-b, shaping results in a decrease to the overall SE of wireless communications. However, as described previously, such decreases to the SE may be compensated by the increased power gain enabled by shaping techniques.

In some aspects, the parallel binary shaping techniques of the present disclosure may enable wireless devices to fine tune the overall shaping rate (R) to achieve desired spectral efficiencies. In other words, the shaping rates of the binary shaping encoders 330-a, 330-b in FIG. 3 may be selected to achieve some overall effective shaping rate (R) in data object 400-b based on the expected SE. In this regard, the shaping rates of multiple binary shaping encoders 330 may be selected or adjusted to achieve some overall effective shaping rate (R) in order to achieve the same defines SEs listed in data objects 400-a, 400-b, or to achieve new SEs.

In other words, in some implementations, new MCS data objects or tables (such as new versions of data objects 400-a, 400-b) may be defined or used for parallel binary shaping. A new table (may define different shaping rates (R), LDPC rates, and QAM order combinations that may be used to achieve different SEs that match the original SEs defined in data object 400-a (such as uniform QAM modulation without PBS), and to achieve intermediate SEs within the original range with fine granularity. That is, a new table may be defined that introduces different shaping rates (R) used by parallel binary encoders to achieve intermediate SEs, such as SE=9.5, 8.4, 7.9, and the like.

Accordingly, in some aspects, wireless devices may communicate or exchange signaling (such as control signaling) or otherwise be pre-configured to perform wireless communications using an indicated MCS, SE, or both. In other words, the wireless devices may communicate (such as transmit or receive) control signaling that indicates an MCS, an SE, or both, where the wireless devices may use the indicated MCS, SE, or both, to obtain, select, calculate or determine the overall effective shaping rate, shaping rates of individual binary shaping encoders, or both. As such, the wireless devices may be configured to use the indicated MCS, SE value, or both, to index the data object 400-b (or a similar table) to select the overall effective shaping rate (R) that is to be used. Subsequently, the wireless devices may be configured select individual shaping rates (such as distribution probabilities) for the respective parallel binary encoders 330 to achieve the selected overall effective shaping rate (R).

For example, in the context of 256 QAM (such as 3 shaped amplitude bits per I and Q PAM), after identifying the overall effective shaping rate (R) for some defined MCS and SE value (such as based on control signaling exchanged between the devices), a wireless device may perform a shaping rate search to identify three respective shaping rates for three separate parallel binary encoders (for the I rail, the Q rail, or both) that will achieve the selected overall effective shaping rate (R). In this example, the wireless device may search over a range of possible triplets of shaping position probabilities (such as triplets of shaping probabilities P₁, P₂, P₃) for the three respective shaped bit positions b₂, b₁, b₀, where the three shaping probabilities P₁, P₂, P₃ are selected to achieve the identified overall effective shaping rate (R). In this example, as noted previously, b₂ may denote the MSB of I or Q PAM, b₁ may denote the second MSB of I or Q PAM, b₀ may denote the LSB of I or Q PAM, and b₃ may denote the sign bit of I or Q PAM.

In other words, the wireless device may select a first shaping probability (such as P₁(b₂=1)) for a first binary shaping encoder, a second shaping probability (such as P₂(b₁=1)) for a second binary shaping encoder, and a third shaping probability (such as P₃(b₀=1)) for a third binary shaping encoder. The respective shaping probabilities P₁, P₂, P₃ of the respective binary shaping encoders may be selected to achieve the previously selected overall effective shaping rate (R) (which may be selected from data object 400-b). In some aspects, to identify the respective shaping probabilities, the wireless devices may be configured to constrain the search to identify monotonically decreasing probabilities. For example, the wireless device may be configured to constrain the search to P(b₂=0)<0.95, where P(b₂=0)>P(b₁=0)>P(b₀), and where P (any b=0)>0.5.

In some aspects, the overall effective shaping rate (R) of respective shaping probability triplets (such as overall effective shaping rate of each P₁, P₂, P₃ triplet, derived from input-output bit relationships) may be graphed in a scatter plot against the resulting power gain of the respective triplet. In other words, different triplets of shaping rates may result in the same overall effective shaping rate (R), but different resulting power gains. As such, wireless devices may be configured to test or otherwise calculate the overall effective shaping rate (R) and corresponding power gain of different combinations of shaping rate triplets. That is, the wireless devices may be configured to identify which shaping rate triplet (such as which values of P₁, P₂, P₃) for a given overall effective shaping rate (R) result in the highest possible power gain.

In general, higher constituent probabilities per shaped bit position may lead to lower overall effective shaping rates (R) (such as input-output relationship function of constituent shaper entropies). Further, lower overall effective shaping rates (R) may lead to higher power scaling gain. For example, Table 1 below illustrates different overall effective shaping rates (R) and corresponding power scaling gain values for 4096 QAM:

TABLE 1
4096 QAM - Tradeoff Between Overall
Effective Shaping Rate and Power Gain

| Overall Effective | Power Scaling |
|---|---|
| Shaping Rate (R) | Gain (dB) |
| 0.96 | 2.4 |
| 0.91 | 4.0 |
| 0.86 | 5.5 |

Referring back to FIG. 3, for a desired shaping rate, a transmitter device may be configured to compute probabilities pᵢ that MSB bit i is 1 (such as search for maximum PAM power gain for a certain fixed PAM entropy or shaping rate). The input coding length Nᵢ for N output bits may be defined as Nᵢ=floor (entropy*N)−margin, where N is the number of PAM symbols per block (such as N=980 to match the number of data tones per 80 MHz symbol), margin defines a small number depending on p and fixed point design to ensure de-mapping has zero loss (such as margin=4), and entropy=p*log₂(p)−(1−p))*log₂(1−p). The deterministic relationship of input length Nᵢ to the output length N may be known on both the Tx and Rx sides, as described previously.

Continuing with the same example, for the input coding length for all MSBs, the transmitter device may compute the total number of input bits in a block of N modulation symbols to select the shaping coding rate. For each block of input bits that fill N QAM symbols, the transmitter device may run Nᵢ bits through the binary shaping encoders 330. For instance, for 256 QAM (8 bits per modulation symbol, 4 I bits and 4 Q bits), the transmitter device may run Nᵢ bits through the binary shaping encoders 330 for six MSBs per QAM symbol (3 per I PAM, 3 per Q PAM).

By way of another example, in some cases, the target shaping rate of the I and Q rail PAM symbols (which form the full QAM symbol) may be the same, in which case the Tx device may select to have the I amplitude bits and the Q amplitude bits share the same set of shapers, and assign that set to produce shaped amplitudes of both I and Q. In other words, the Tx device may select to use the same bank of binary shaping encoders 330 for shaping both the I and Q amplitude bit streams. In such cases, the Tx device may input twice the number of bits (2*Nᵢ bits) through each individual binary shaping encoder 330, where each binary shaping encoder may output 2N bits, to generate 2N N PAM symbols (I and Q), which are used to form N QAM symbols.

As described with reference to block 335 in FIG. 3, shaping may be performed with “natural” mapping of PAM amplitudes to binary representations. Following the parallel shaping by the binary shaping encoders 330, the binary representations of amplitudes may be re-mapped to Gray coded binary representations. Subsequently, the Gray coded I and Q PAM amplitude bits may be serialized and sent directly to LDPC Encoder for remainder of QAM shaping process (block 340).

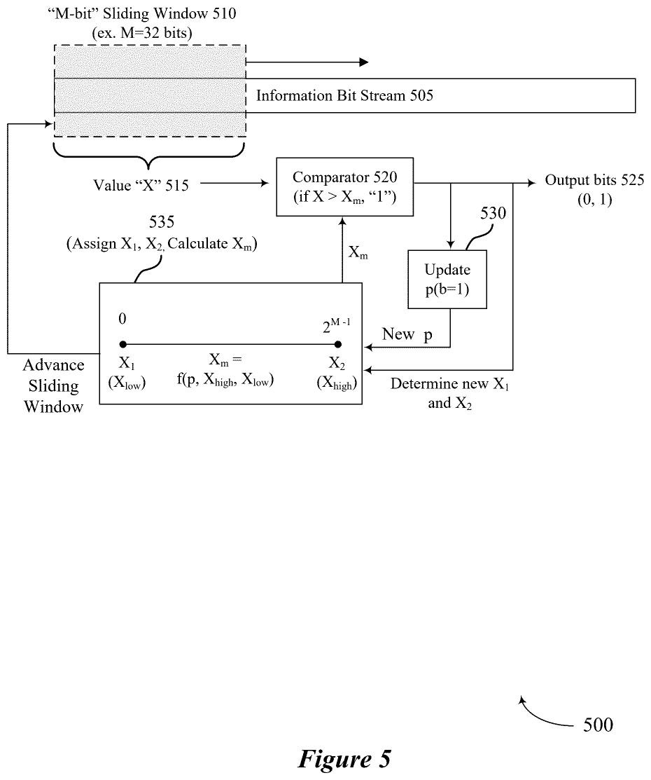

FIG. 5 shows an example of a binary shaping encoder 500 that supports techniques for parallel binary shaping. Aspects of the binary shaping encoder 500 may implement, or be implemented by, the wireless communication network 100, the transmitter 200, the probabilistic shaping configuration 300, the data objects 400-a, 400-b, or any combination thereof.

For example, the binary shaping encoder 500 shown and described in FIG. 5 may be an example of the binary shaping encoders 330-a, 330-b shown and described in FIG. 3. In this regard, the binary shaping encoder 500 may be configured to receive parallelized bit streams of an information bit stream 505, perform some distribution mapping as part of a binary shaping operation, and generate output bits 525 (such as shaped output bits) that will be used downstream for generating modulation symbols (such as QAM symbols) that will be transmitted to an Rx device via a message.

As shown in FIG. 5, the binary shaping encoder 500 may utilize a sliding window 510 that “slides” across the information bit stream 505 to perform shaping. For example, the sliding window 510 may span M bits of the information bit stream 505, such as 32 bits. The size (M) of the sliding window 510 may be a fixed-point design choice, where larger values of M are associated with higher efficiencies. In some aspects, the binary shaping encoder 500 may calculate some value X 515 based on the respective bit positions included within the sliding window 510. As such, the value X 515 may include an integer representation of the sliding window 510 of M input bits.

The binary shaping encoder 500 may be associated with some probability distribution or target shaping rate p, which defines the probability that the respective output bits 525 will be equal to 1. For instance, as shown in FIG. 3, the first binary shaping encoder 330-a may be associated with a shaping rate of 0.9 (such as p=0.9). Additionally, at block 535, the binary shaping encoder 500 may be assign a “high” value of X (X₂, or X_{high}) and a “low” value of X (X₁, or X_{low}), and calculate a “midpoint” of X (Xₘ). The mid-range point divides the range between X₁ and X₂ according to a probability of an output bit 525 being 1. For initialization, prior to taking in input bits, the value of X₁ is set to 0, the value of X₂ is set to 2^{M}−1, and Xₘ is calculated and assigned as (2^{M}−1)−ceil((2^{M}−1)*p). In some implementations, the binary shaping encoder 500 may select or otherwise track X₁, Xₘ, X₂ as M-bit integer values. Further, the binary shaping encoder 500 may keep track of low, high, and mid-range points of the value X 515 as the binary shaping encoder 500 generates output bits 525.

For example, the binary shaping encoder 500 may input the value X 515 into a comparator 520, where comparator 520 determines whether the value X 515 is greater than (or less than or equal to) Xₘ. If the comparator 520 determines that the value X 515 is greater than Xₘ (such as X>Xₘ), the binary shaping encoder 500 may generate an output bit 525 that is equal to “1.” Conversely, if the comparator 520 determines that the value X 515 is not greater than Xₘ (such as X≤Xₘ), the binary shaping encoder 500 may generate an output bit 525 that is equal to “0.” That is, the output bit 525 may be included within a shaped bit stream output by the binary shaping encoder 500.

In some aspects, the output bit 525 (such as either “1” or “0”) may be used to update the shaping rate p at block 530. That is, the shaping rate p may be iteratively adjusted as the binary shaping encoder 500 generates output bits 525 in order to achieve the target shaping rate of the encoder. For example, referring to FIG. 3, the first binary shaping encoder 330-a may iteratively adjust the shaping rate used for subsequent output bits (such as shaped bits) in order to achieve the target shaping rate of p=0.9. The binary shaping encoder 500 may update p as p=(Nᵢ−Numₒₙₑₛ)/N−Cnt, where Nᵢ is the desired number of “1”s for MSB i in a block of N modulation symbols, and where Numₒₙₑₛ is the number of “1”s for MSB i produced thus far at output modulation symbol number Cnt. In some implementations, the value 1/N-Cnt may be selected from a look-up table (LUT) or other data object to avoid a division.

Additionally, in some aspects, the output bit 525 (such as either “1” or “0”) may be used to adjust the values of X₁, X₂, or both (such as calculate or select new values of X_{low}, X_{high}, or both). For example, if the output bit 525 is equal to 1, the binary shaping encoder 500 may set X₁=Xₘ+1. Otherwise, if the output bit 525 is equal to 0, the binary shaping encoder 500 may set X₂=Xₘ. After each output bit 525, the binary shaping encoder 500 may recalculate Xₘ as Xₘ=X₂−ceil ((X₂−X₁)*p). For random input data, X<Xₘ may occur more frequently, as shaping produces more output bits 525 of “0” than “1” where p (bit=1) is smaller than 0.5. By updating p after each output bit 525 is generated, the binary shaping encoder 500 may ensure that shaping produces exactly Nᵢ output “1”s for MSB i in every block of N output bits. Further, updated values determined at block 535 may be used to advance the sliding window 510 across the information bit stream 505 (such as to determine a new value X 515).

In some aspects, an output bit 525 (and updating p, X₁, X₂) may be generated multiple times without reading any new input bit (such as without reading a new value X 515), hence the quantity of output bits 525 may be greater than the quantity of input bits within the sliding window 510 to guarantee a fixed number of “1”s in the output (and adding redundancy). In some aspects, if MSB(X₁)=MSB(X₂), the binary shaping encoder 500 may be configured to renormalize as follows: X₁=X₁<<1, X₂=(X₂<<1)+1, and reading a new input bit b: X=(X<<1)+b. This reading of a new input bit constitutes advancing the sliding window. As described previously, X, X₁, Xₘ, X₂ can be tracked as M-bit integer values, where <<would be a left-wise bit shift of the binary representation of those integers (and bit-growth past M-bits is truncated away).

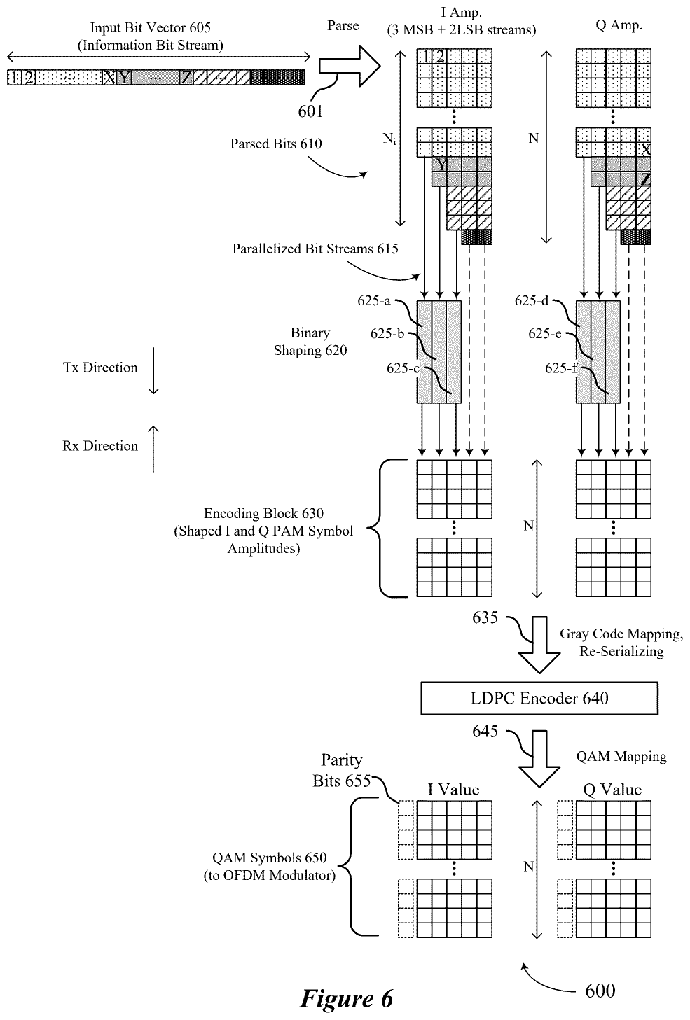

FIG. 6 shows an example of a process flow 600 that supports techniques for parallel binary shaping. Aspects of the process flow 600 may implement, or be implemented by, the wireless communication network 100, the transmitter 200, the probabilistic shaping configuration 300, the data objects 400-a, 400-b, the binary shaping encoder 500, or any combination thereof.

In particular, the process flow 600 illustrates example blocks, steps, or operations that may be performed by a Tx device to generate a message using parallel binary shaping operations (and, inversely, example blocks, steps, and operations that may be performed in reverse by an Rx device to decode a message using parallel binary deshaping operations). In this regard, the process flow 600 may illustrate a more detailed example of parallel binary shaping encoders shown and described in FIG. 3.

As shown in the process flow 600, a Tx device may receive, obtain, select or otherwise identify an input bit vector 605 that includes information to be transmitted to an Rx device. That is, the input bit vector 605 may be an example of the information bit stream 310 in FIG. 3, the information bit stream 505 in FIG. 5, or both. The input bit vector 605 may include a set of bits for transmission, denoted as bit indexes 1, 2, . . . , X, Y, Z, and the like. At 601, the Tx device may parse the input bit vector 605 to generate parsed bits 610. In some aspects, the input bit vector 605 may map to inputs of respective parallelized bit streams 615 according to some distribution rule. For example, as shown in FIG. 6, the respective bits of the input bit vector 605 may be “painted” or otherwise organized horizontally across bit positions, then downwards (such as bit positions 1, 2, . . . , 10 along the first row, then bit positions 11, 12, . . . , 20 along the second row, and the like).

In particular, the Tx device may parse the input bit vector 605 into different sets of bits (such as different parallelized bit streams 615) that will be input into respective binary shaping encoders 625. As shown in FIG. 6, the input bit vector 605 may be parsed into bits for the I component and the Q component. For instance, in the context of 4096 QAM constellation shaping, as shown in FIG. 6, each of the I amplitude component and the Q amplitude component may include three parallelized bit streams 615 for 3 MSBs, and two parallelized bit streams for two LSBs.

At 620, the respective parallelized bit streams 615 may be input into respective binary shaping encoders 625. For example, in the context of 4096 QAM with three MSB positions (such as three parallelized bit streams 615) shaped for each of the I and Q amplitude bit positions, the three respective parallelized bit streams 615 corresponding to the I amplitude bit positions may be input into three binary shaping encoders 625-a, 625-b, and 625-c, and the three parallelized bit streams 615 corresponding to the Q amplitude bit positions may be input into three binary shaping encoders 625-c, 625-d, and 625-e.

In some aspects, each respective binary shaping encoder 625 may run independently from one another and be associated with their own target probability of shaping rate p. In some aspects, the target probabilities or shaping rates across the respective binary shaping encoders 625 may be monotonically decreasing from MSBs to LSBs. That is, the binary shaping encoders 625-a, 625-b, and 625-c may be associated with respective shaping rates p₁, p₂, and p₃, where p₁≥ p₂≥p₃.

Further, in some aspects, as shown in FIG. 6, the input bit vector 605 may be parsed such that the quantity of input bits Nᵢ for each respective parallelized bit stream 615 for the respective I and Q components is monotonically increasing from MSB downwards, to reflect the case that the target probabilities over those bit positions is monotonically decreasing. That is, the three parallelized bit streams 615 for the I amplitude bit positions may be associated with respective input lengths Nᵢ₁, Nᵢ₂, and Nᵢ₃, where Nᵢ₁≤Nᵢ₂≤Nᵢ₃.

In some aspects, the value of Nᵢ may be a function of the shaping rate p(bit=1) for the respective parallelized bit stream 615 “i” input into the respective binary shaping encoder 625. In other words, Nᵢ, which represents the number of input bits per encoder for parallelized bit stream i, may be deterministic and known. In particular, the value of Nᵢ may be deterministic and known given the 4096 QAM shaping probability “triplet” (such as shaping rates p₁, p₂, p₃ for the three respective binary shaping encoders 625 for the I and Q components) and a fixed encoding block depth “N” (such as total I+Q amplitude pairs to produce). In this regard, the ratio between the Nᵢ (such as quantity of input bits) and N (such as quantity of output bits) may be deterministic and known to both the Tx and Rx devices.

As shown in FIG. 6, two parallelized bit streams 615 for each of the I amplitude bit positions and the Q amplitude bit positions may go unshaped (such as not shaped by corresponding binary shaping encoders 625).

In some aspects, the Tx device may generate an encoding block 630, which includes shaped I and Q PAM symbol amplitudes. In this regard, the Tx device may generate the encoding block 630 by shaping the six respective parallelized bit streams 615 for the I/Q MSBs using the six parallel binary shaping encoders 625-a, 625-b, 625-c, 625-d, 625-e, and 625-f, and by leaving the four respective parallelized bit streams 615 for the I/Q LSBs unshaped. As such, the encoding block 630 shown and described in FIG. 6 may be an example of shaped bit stream(s) that are output from the parallel binary shaping encoders 625.

The set of parallel binary shaping encoders 625 may be configured to shape the amplitude bit positions (such as MSB amplitude bit positions of the I and Q components) in order to adjust the usage frequency or probability of the modulation symbol amplitudes (from a statistical perspective) of a modulation constellation. That is, the set of parallel binary shaping encoders 625 may be configured shape the bit positions of the I/Q component amplitude bit positions in order to achieve a statistical usage of symbols that are monotonically decreasing relative to the origin. For example, as shown and described in FIG. 3, the set of parallel binary shaping encoders 625 may be configured to shape the parallelized bit streams 615 so that modulation symbols or constellation points closer to the origin are used more frequently than modulation symbols or constellation points further from the origin. Moreover, because modulation symbols or constellation points closer to the origin use have lower symbol energy, the set of parallel binary shaping encoders 625 may reduce the average power required to encode the information, thereby enabling for higher signal scaling at the Tx and power gain that may be realized as improved SNR at the Rx device for more efficient and reliable communications.

Continuing with reference to the process flow 600, the Tx device may convert linear binary values of the encoding block 630 to Gray coded values (as shown and described in block 335 in FIG. 3). That is, the encoding block 630 may be converted using a Gray code map. Further, the encoding block 630 may be re-serialized before being input into an LDPC encoder 640. In this regard, the encoding block 630 (such as shaped bit streams with shaped I and Q amplitudes) may be used as inputs to the LDPC encoder 640 as systematic bits (such as not altered by FEC). As described previously, the LDPC encoder 640 may be configured to add parity bits 655 to the encoding block 630. Following the LDPC encoder 640, the Tx device may perform QAM mapping at 645 to map the bits to modulation symbols of a modulation constellation to generate the QAM symbols 650. In this example, the parity bits 655 from the LDPC encoding process may be distributed across the shaped I and Q amplitudes to form complete 4096 QAM symbols 650. The overall QAM symbol(s) 650 may still be shaped, as sign from parity bit does not alter the power distributions of I and Q. Subsequently, the QAM symbols 650 may be provided to a OFDM modulator to generate a message that is transmitted to the Rx device.

While the process flow 600 shown in FIG. 6 is primarily described in the context of the Tx device (such as in the “Tx direction”), the respective blocks and operations of the process flow 600 may be performed in reverse at the Rx device (such as in the “Rx direction”). For example, the Rx device may receive the message that includes the QAM symbols 650, de-map the QAM symbols (inverse of block 645) and generate an encoding block 630 of the shaped I and Q PAM symbol amplitudes (such as LDPC encoder 640, inverse of block 635). That is, the Rx device may generate shaped bit streams (such as shaped bit streams of the encoding block 630) based on the received message and convert the Gray coded representations to linear coded representations, as descried previously. The Rx device may then input the shaped bit streams (of the encoding block 630) into separate parallel binary deshaping encoders (inverse of binary shaping at 620, or “binary deshaping”) to regenerate or retrieve the parallelized bit streams 615. The Rx device may then repackage the parallelized bit streams 615 to retrieve the input bit vector 605 (inverse parsing at 601), where the Rx device may then process the information included within the retrieved input bit vector 605.

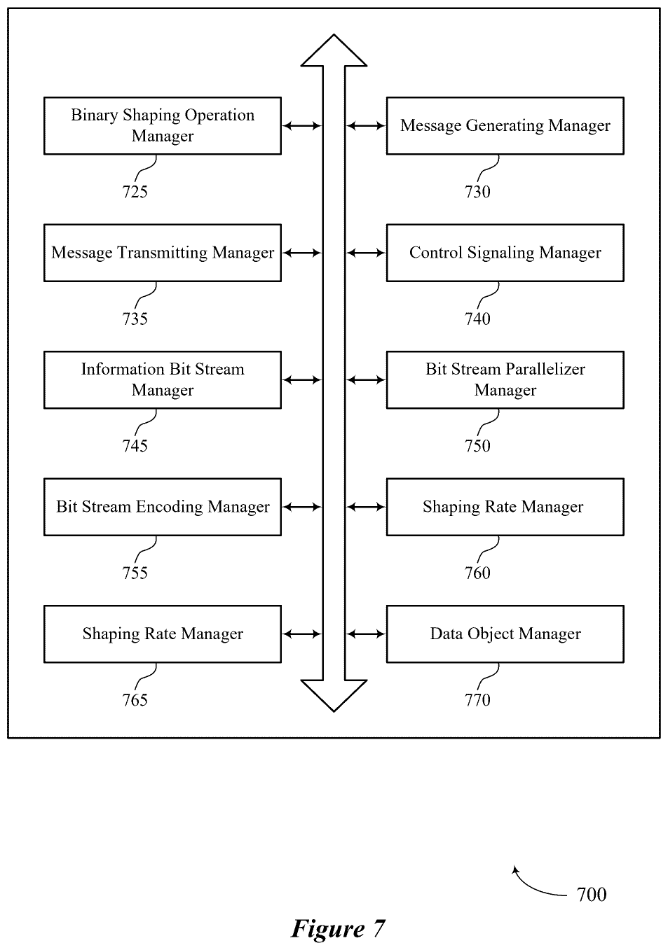

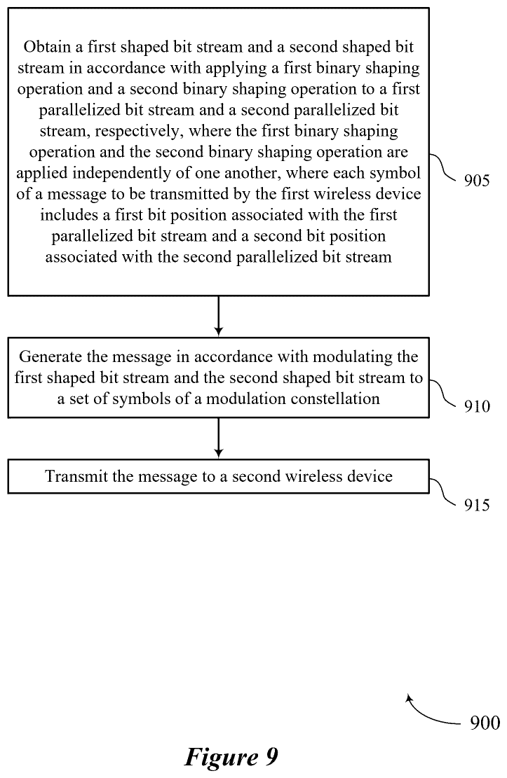

FIG. 7 shows a block diagram of an example wireless communication device 700 that supports techniques for parallel binary shaping. In some implementations, the wireless communication device 700 is configured to perform the process 900 described with reference to FIG. 9. The wireless communication device 700 may include one or more chips, SoCs, chipsets, packages, components or devices that individually or collectively constitute or include a processing system. The processing system may interface with other components of the wireless communication device 700, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 700 may transmit the information output from the chip. In such an example, the second interface may refer to an interface between the processing system of the chip and a reception component, such that the wireless communication device 700 may receive information that is then passed to the processing system. In some such examples, the first interface also may obtain information, such as from the transmission component, and the second interface also may output information, such as to the reception component.

The processing system of the wireless communication device 700 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, in some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 700 can be configurable or configured for use in a STA, such as the STA 104 described with reference to FIG. 1. In some other examples, the wireless communication device 700 can be a STA that includes such a processing system and other components including multiple antennas. The wireless communication device 700 is capable of transmitting and receiving wireless communications in the form of, for example, wireless packets. For example, the wireless communication device 700 can be configurable or configured to transmit and receive packets in the form of physical layer PPDUs and MPDUs conforming to one or more of the IEEE 802.11 family of wireless communication protocol standards. In some other examples, the wireless communication device 700 can be configurable or configured to transmit and receive signals and communications conforming to one or more 3GPP specifications including those for 5G NR or 6G. In some implementations, the wireless communication device 700 also includes or can be coupled with one or more application processors which may be further coupled with one or more other memories. In some implementations, the wireless communication device 700 further includes a user interface (UI) (such as a touchscreen or keypad) and a display, which may be integrated with the UI to form a touchscreen display that is coupled with the processing system. In some implementations, the wireless communication device 700 may further include one or more sensors such as, for example, one or more inertial sensors, accelerometers, temperature sensors, pressure sensors, or altitude sensors, that are coupled with the processing system.

The wireless communication device 700 includes a binary shaping operation manager 725, a message generating manager 730, a message transmitting manager 735, a control signaling manager 740, an information bit stream manager 745, a bit stream parallelizer manager 750, a bit stream encoding manager 755, a shaping rate manager 760, a shaping rate manager 765, and a data object manager 770. Portions of one or more of the binary shaping operation manager 725, the message generating manager 730, the message transmitting manager 735, the control signaling manager 740, the information bit stream manager 745, the bit stream parallelizer manager 750, the bit stream encoding manager 755, the shaping rate manager 760, the shaping rate manager 765, and the data object manager 770 may be implemented at least in part in hardware or firmware. For example, one or more of the binary shaping operation manager 725, the message generating manager 730, the message transmitting manager 735, the control signaling manager 740, the information bit stream manager 745, the bit stream parallelizer manager 750, the bit stream encoding manager 755, the shaping rate manager 760, the shaping rate manager 765, and the data object manager 770 may be implemented at least in part by at least a processor or a modem. In some implementations, portions of one or more of the binary shaping operation manager 725, the message generating manager 730, the message transmitting manager 735, the control signaling manager 740, the information bit stream manager 745, the bit stream parallelizer manager 750, the bit stream encoding manager 755, the shaping rate manager 760, the shaping rate manager 765, and the data object manager 770 may be implemented at least in part by a processor and software in the form of processor-executable code stored in memory.

The wireless communication device 700 may support wireless communications in accordance with examples as disclosed herein. The binary shaping operation manager 725 is configurable or configured to obtain a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each modulation symbol of a message to be transmitted by the first wireless device includes a first bit position associated with the first parallelized bit stream and a second bit position associated with the second parallelized bit stream. The message generating manager 730 is configurable or configured to generate the message in accordance with modulating the first shaped bit stream and the second shaped bit stream to a set of modulation symbols of a modulation constellation. The message transmitting manager 735 is configurable or configured to transmit the message to a second wireless device.

In some implementations, the first binary shaping operation is associated with a first bit ratio between the first parallelized bit stream and the first shaped bit stream. In some implementations, the second binary shaping operation is associated with a second bit ratio between the second parallelized bit stream and the second shaped bit stream. In some implementations, the first bit ratio and the second bit ratio are fixed.

In some implementations, the control signaling manager 740 is configurable or configured to communicate control signaling with the second wireless device, a third wireless device, or both, where the control signaling indicates an MCS, an SE value, or both, associated with communications between the first wireless device and the second wireless device, where a first shaping rate associated with the first binary shaping operation and a second shaping rate associated with the second binary shaping operation are selected in accordance with the MCS, the SE value, or both.

In some implementations, the shaping rate manager 760 is configurable or configured to select an overall effective shaping rate in accordance with the MCS, the SE value, or both. In some implementations, the shaping rate manager 765 is configurable or configured to select the first shaping rate for the first binary shaping operation and the second shaping rate for the second binary shaping operation in accordance with the overall effective shaping rate, where the first shaping rate is greater than or equal to the second shaping rate.

In some implementations, the data object manager 770 is configurable or configured to index a data object using the MCS, the SE value, or both, to select the first shaping rate and the second shaping rate.

In some implementations, the control signaling manager 740 is configurable or configured to receive additional control signaling indicating the data object, where the data object includes mappings between a set of multiple MCSs, a set of multiple SE values, and a set of multiple effective shaping rates, where the data object is indexed in accordance with receiving the additional control signaling.

In some implementations, the first bit position associated with the first parallelized bit stream includes a first amplitude bit position of an I component of each symbol of the message, a Q component of each symbol of the message, or both. In some implementations, the second bit position associated with the second parallelized bit stream includes a second amplitude bit position of the I component of each symbol of the message, the Q component of each symbol of the message, or both.

In some implementations, the first binary shaping operation and the second binary shaping operation are applied to the first parallelized bit stream and the second parallelized bit stream, respectively, in accordance with linear binary representations of the set of symbols of the modulation constellation. In some implementations, the message is generated in accordance with mapping the linear binary representations of the first shaped bit stream and the second shaped bit stream to Gray coded representations of the set of symbols.

In some implementations, the binary shaping operation manager 725 is configurable or configured to apply a third binary shaping operation to a third parallelized bit stream to generate a third shaped bit stream, where the third binary shaping operation is applied in parallel and independently relative to the first binary shaping operation and the second binary shaping operation, where each symbol of the message includes a third bit position associated with the third parallelized bit stream, where the third shaped bit stream is modulated to the set of symbols of the modulation constellation to generate the message.

In some implementations, the first binary shaping operation, the second binary shaping operation, and the third binary shaping operation are associated with a first shaping rate, a second shaping rate, and a third shaping rate, respectively. In some implementations, the first shaping rate, the second shaping rate, and the third shaping rate include monotonically decreasing shaping rates.

In some implementations, the first binary shaping operation and the second binary shaping operation are associated with a first shaping rate and a second shaping rate, respectively. In some implementations, the first shaped bit stream and the second shaped bit stream are modulated to the set of symbols of the modulation constellation in accordance with the first shaping rate and the second shaping rate such that a selection frequency of the set of symbols of the modulation constellation is monotonically decreasing relative to an origin of the modulation constellation.

In some implementations, the information bit stream manager 745 is configurable or configured to select an information bit stream for transmission. In some implementations, the bit stream parallelizer manager 750 is configurable or configured to generate the first parallelized bit stream, the second parallelized bit stream, and a third parallelized bit stream from the information bit stream. In some implementations, the bit stream encoding manager 755 is configurable or configured to encode the first shaped bit stream, the second shaped bit stream, and the third parallelized bit stream in accordance with applying the first binary shaping operation and the second binary shaping operation to the first parallelized bit stream and the second parallelized bit stream, respectively, and in accordance with maintaining the third parallelized bit stream as an unshaped bit stream, where the message is generated in accordance with the encoding.

In some implementations, the first binary shaping operation is applied via a first binary encoder component. In some implementations, the second binary shaping operation is applied via a second binary encoder component.

In some implementations, receive an input set of bits from an information bit stream. In some implementations, generate an output set of bits in accordance with the input set of bits and a mapping function, where a distribution of values of the output set of bits is in accordance with the target shaping rate, and where the first shaped bit stream includes the output set of bits.

In some implementations, a ratio between a first quantity of bits of the input set of bits and a second quantity of bits of the output set of bits is in accordance with the target shaping rate.

In some implementations, the first parallelized bit stream is associated with a set of multiple most significant bits of a set of multiple symbols of the message. In some implementations, the second parallelized bit stream is associated with a set of multiple least significant bits of the set of multiple symbols of the message. In some implementations, the first bit position and the second bit position correspond to the set of multiple most significant bits and the set of multiple least significant bits, respectively.

In some implementations, the modulation constellation includes a 4 k QAM modulation constellation, a 1 k QAM modulation constellation, a 256 QAM modulation constellation, a 64 QAM modulation constellation, a 16 QAM modulation constellation, or any combination thereof.

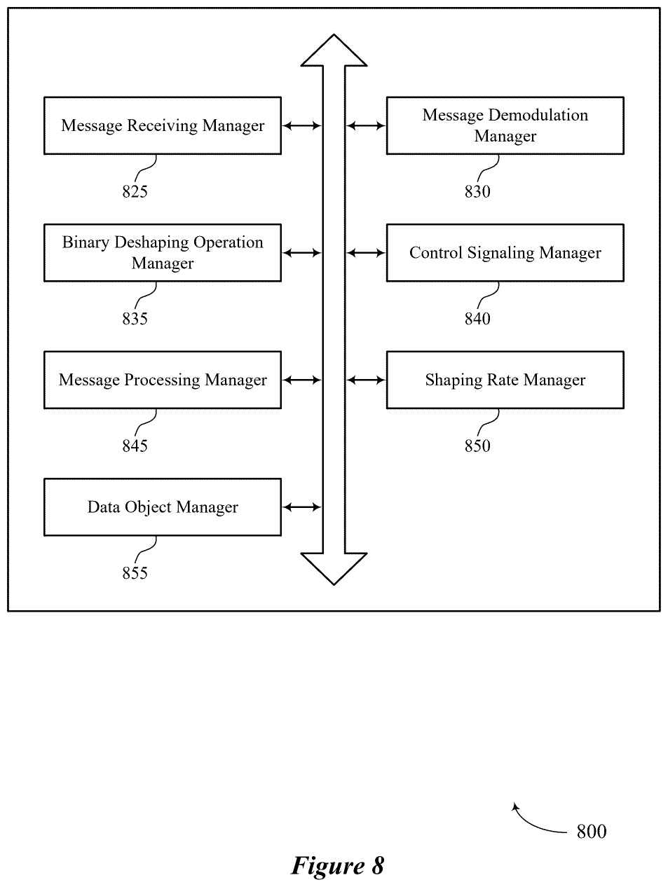

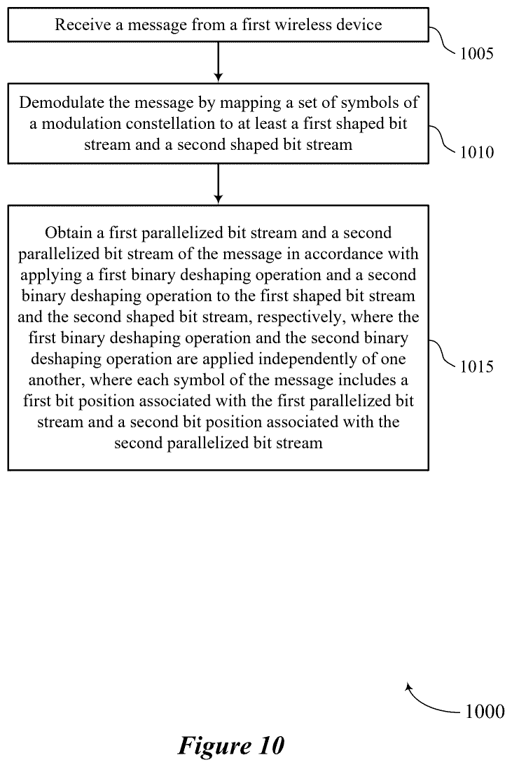

FIG. 8 shows a block diagram of an example wireless communication device 800 that supports techniques for parallel binary shaping. In some implementations, the wireless communication device 800 is configured to perform the process 1000 described with reference to FIG. 10. The wireless communication device 800 may include one or more chips, SoCs, chipsets, packages, components or devices that individually or collectively constitute or include a processing system. The processing system may interface with other components of the wireless communication device 800, and may generally process information (such as inputs or signals) received from such other components and output information (such as outputs or signals) to such other components. In some aspects, an example chip may include a processing system, a first interface to output or transmit information and a second interface to receive or obtain information. For example, the first interface may refer to an interface between the processing system of the chip and a transmission component, such that the wireless communication device 800 may transmit the information output from the chip. In such an example, the second interface may refer to an interface between the processing system of the chip and a reception component, such that the wireless communication device 800 may receive information that is then passed to the processing system. In some such examples, the first interface also may obtain information, such as from the transmission component, and the second interface also may output information, such as to the reception component.

The processing system of the wireless communication device 800 includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), or digital signal processors (DSPs)), processing blocks, application-specific integrated circuits (ASIC), programmable logic devices (PLDs) (such as field programmable gate arrays (FPGAs)), or other discrete gate or transistor logic or circuitry (all of which may be generally referred to herein individually as “processors” or collectively as “the processor” or “the processor circuitry”). One or more of the processors may be individually or collectively configurable or configured to perform various functions or operations described herein. The processing system may further include memory circuitry in the form of one or more memory devices, memory blocks, memory elements or other discrete gate or transistor logic or circuitry, each of which may include tangible storage media such as random-access memory (RAM) or ROM, or combinations thereof (all of which may be generally referred to herein individually as “memories” or collectively as “the memory” or “the memory circuitry”). One or more of the memories may be coupled with one or more of the processors and may individually or collectively store processor-executable code that, when executed by one or more of the processors, may configure one or more of the processors to perform various functions or operations described herein. Additionally, or alternatively, In some implementations, one or more of the processors may be preconfigured to perform various functions or operations described herein without requiring configuration by software. The processing system may further include or be coupled with one or more modems (such as a Wi-Fi (for example, IEEE compliant) modem or a cellular (for example, 3GPP 4G LTE, 5G or 6G compliant) modem). In some implementations, one or more processors of the processing system include or implement one or more of the modems. The processing system may further include or be coupled with multiple radios (collectively “the radio”), multiple RF chains or multiple transceivers, each of which may in turn be coupled with one or more of multiple antennas. In some implementations, one or more processors of the processing system include or implement one or more of the radios, RF chains or transceivers.

In some implementations, the wireless communication device 800 can be configurable or configured for use in an AP, such as the AP 102 described with reference to FIG. 1. In some other examples, the wireless communication device 800 can be an AP that includes such a processing system and other components including multiple antennas. The wireless communication device 800 is capable of transmitting and receiving wireless communications in the form of, for example, wireless packets. For example, the wireless communication device 800 can be configurable or configured to transmit and receive packets in the form of physical layer PPDUs and MPDUs conforming to one or more of the IEEE 802.11 family of wireless communication protocol standards. In some other examples, the wireless communication device 800 can be configurable or configured to transmit and receive signals and communications conforming to one or more 3GPP specifications including those for 5G NR or 6G. In some implementations, the wireless communication device 800 also includes or can be coupled with one or more application processors which may be further coupled with one or more other memories. In some implementations, the wireless communication device 800 further includes at least one external network interface coupled with the processing system that enables communication with a core network or backhaul network that enables the wireless communication device 800 to gain access to external networks including the Internet.

The wireless communication device 800 includes a message receiving manager 825, a message demodulation manager 830, a binary deshaping operation manager 835, a control signaling manager 840, a message processing manager 845, a shaping rate manager 850, and a data object manager 855. Portions of one or more of the message receiving manager 825, the message demodulation manager 830, the binary deshaping operation manager 835, the control signaling manager 840, the message processing manager 845, the shaping rate manager 850, and the data object manager 855 may be implemented at least in part in hardware or firmware. For example, one or more of the message receiving manager 825, the message demodulation manager 830, the binary deshaping operation manager 835, the control signaling manager 840, the message processing manager 845, the shaping rate manager 850, and the data object manager 855 may be implemented at least in part by at least a processor or a modem. In some implementations, portions of one or more of the message receiving manager 825, the message demodulation manager 830, the binary deshaping operation manager 835, the control signaling manager 840, the message processing manager 845, the shaping rate manager 850, and the data object manager 855 may be implemented at least in part by a processor and software in the form of processor-executable code stored in memory.

The wireless communication device 800 may support wireless communications in accordance with examples as disclosed herein. The message receiving manager 825 is configurable or configured to receive a message from a first wireless device. The message demodulation manager 830 is configurable or configured to demodulate the message by mapping a set of symbols of a modulation constellation to at least a first shaped bit stream and a second shaped bit stream. The binary deshaping operation manager 835 is configurable or configured to obtain a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream.

In some implementations, the first binary deshaping operation is associated with a first bit ratio between the first parallelized bit stream and the first shaped bit stream. In some implementations, the second binary deshaping operation is associated with a second bit ratio between the second parallelized bit stream and the second shaped bit stream. In some implementations, the first bit ratio and the second bit ratio are fixed.

In some implementations, the control signaling manager 840 is configurable or configured to communicate control signaling with the first wireless device, a third wireless device, or both, where the control signaling indicates an MCS, an SE value, or both, associated with communications between the first wireless device and the second wireless device, where a first shaping rate associated with the first binary deshaping operation and a second shaping rate associated with the second binary deshaping operation are selected in accordance with the MCS, the SE value, or both.

In some implementations, the shaping rate manager 850 is configurable or configured to select an overall effective shaping rate in accordance with the MCS, the SE value, or both. In some implementations, the shaping rate manager 850 is configurable or configured to select the first shaping rate for the first binary deshaping operation and the second shaping rate for the second binary deshaping operation in accordance with the overall effective shaping rate, where the first shaping rate is greater than or equal to the second shaping rate.

In some implementations, the data object manager 855 is configurable or configured to index a data object using the MCS, the SE value, or both, to select the first shaping rate and the second shaping rate.

In some implementations, the control signaling manager 840 is configurable or configured to receive additional control signaling indicating the data object, where the data object includes mappings between a set of multiple MCSs, a set of multiple SE values, and a set of multiple effective shaping rates, where the data object is indexed in accordance with receiving the additional control signaling.

In some implementations, the first binary deshaping operation and the second binary deshaping operation are applied to the first shaped bit stream and the second shaped bit stream, respectively, in accordance with Gray coded binary representations of the set of symbols of the modulation constellation. In some implementations, the first parallelized bit stream and the second parallelized bit stream are obtained in accordance with mapping the Gray coded binary representations to linear binary representations of the first shaped bit stream and the second shaped bit stream.

In some implementations, the binary deshaping operation manager 835 is configurable or configured to apply a third binary deshaping operation to a third shaped bit stream of the message to generate a third parallelized bit stream, where the third binary deshaping operation is applied in parallel and independently relative to the first binary deshaping operation and the second binary deshaping operation, where each symbol of the message includes a third bit position associated with the third parallelized bit stream.

In some implementations, the first binary deshaping operation, the second binary deshaping operation, and the third binary deshaping operation are associated with a first shaping rate, a second shaping rate, and a third shaping rate, respectively. In some implementations, the first shaping rate, the second shaping rate, and the third shaping rate include monotonically decreasing shaping rates.

In some implementations, the message receiving manager 825 is configurable or configured to generate the first shaped bit stream, the second shaped bit stream, and a third unshaped bit stream from the message. In some implementations, the message receiving manager 825 is configurable or configured to decode the first shaped bit stream, the second shaped bit stream, and the third unshaped bit stream, where the message is processed in accordance with applying the first binary deshaping operation and the second binary deshaping operation to the first shaped bit stream and the second shaped bit stream, respectively.

In some implementations, the first binary deshaping operation is applied via a first binary decoder component. In some implementations, the second binary deshaping operation is applied via a second binary decoder component.

In some implementations, the first parallelized bit stream is associated with a set of multiple most significant bits of a set of multiple symbols of the message. In some implementations, the second parallelized bit stream is associated with a set of multiple least significant bits of the set of multiple symbols of the message. In some implementations, the first bit position and the second bit position correspond to the set of multiple most significant bits and the set of multiple least significant bits, respectively.

In some implementations, the modulation constellation includes a 4 k QAM modulation constellation, a 1 k QAM modulation constellation, a 256 QAM modulation constellation, a 64 QAM modulation constellation, a 16 QAM modulation constellation, or any combination thereof.

In some implementations, the message processing manager 845 is configurable or configured to process the message in accordance with applying the first binary deshaping operation and the second binary deshaping operation.

FIG. 9 shows a flowchart illustrating an example process 900 performable by or at a first wireless device that supports techniques for parallel binary shaping. The operations of the process 900 may be implemented by a first wireless device or its components as described herein. For example, the process 900 may be performed by a wireless communication device, such as the wireless communication device 700 described with reference to FIG. 7, operating as or within a wireless STA. In some implementations, the process 900 may be performed by a wireless STA, such as one of the STAs 104 described with reference to FIG. 1.

In some implementations, in 905, the first wireless device may obtain a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each symbol of a message to be transmitted by the first wireless device includes a first bit position associated with the first parallelized bit stream and a second bit position associated with the second parallelized bit stream. The operations of 905 may be performed in accordance with examples as disclosed herein. In some implementations, aspects of the operations of 905 may be performed by a binary shaping operation manager 725 as described with reference to FIG. 7.

In some implementations, in 910, the first wireless device may generate the message in accordance with modulating the first shaped bit stream and the second shaped bit stream to a set of symbols of a modulation constellation. The operations of 910 may be performed in accordance with examples as disclosed herein. In some implementations, aspects of the operations of 910 may be performed by a message generating manager 730 as described with reference to FIG. 7.

In some implementations, in 915, the first wireless device may transmit the message to a second wireless device. The operations of 915 may be performed in accordance with examples as disclosed herein. In some implementations, aspects of the operations of 915 may be performed by a message transmitting manager 735 as described with reference to FIG. 7.

FIG. 10 shows a flowchart illustrating an example process 1000 performable by or at a second wireless device that supports techniques for parallel binary shaping. The operations of the process 1000 may be implemented by a second wireless device or its components as described herein. For example, the process 1000 may be performed by a wireless communication device, such as the wireless communication device 800 described with reference to FIG. 8, operating as or within a wireless AP. In some implementations, the process 1000 may be performed by a wireless AP, such as one of the APs 102 described with reference to FIG. 1.

In some implementations, in 1005, the second wireless device may receive a message from a first wireless device. The operations of 1005 may be performed in accordance with examples as disclosed herein. In some implementations, aspects of the operations of 1005 may be performed by a message receiving manager 825 as described with reference to FIG. 8.

In some implementations, in 1010, the second wireless device may demodulate the message by mapping a set of symbols of a modulation constellation to at least a first shaped bit stream and a second shaped bit stream. The operations of 1010 may be performed in accordance with examples as disclosed herein. In some implementations, aspects of the operations of 1010 may be performed by a message demodulation manager 830 as described with reference to FIG. 8.

In some implementations, in 1015, the second wireless device may obtain a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream. The operations of 1015 may be performed in accordance with examples as disclosed herein. In some implementations, aspects of the operations of 1015 may be performed by a binary deshaping operation manager 835 as described with reference to FIG. 8.

Implementation examples are described in the following numbered clauses:

The following provides an overview of aspects of the present disclosure:

Aspect 1: A method for wireless communications at a first wireless device, including: obtaining a first shaped bit stream and a second shaped bit stream in accordance with applying a first binary shaping operation and a second binary shaping operation to a first parallelized bit stream and a second parallelized bit stream, respectively, where the first binary shaping operation and the second binary shaping operation are applied independently of one another, where each symbol of a message to be transmitted by the first wireless device includes a first bit position associated with the first parallelized bit stream and a second bit position associated with the second parallelized bit stream; generating the message in accordance with modulating the first shaped bit stream and the second shaped bit stream to a set of symbols of a modulation constellation; and transmitting the message to a second wireless device.

Aspect 2: The method of aspect 1, where the first binary shaping operation is associated with a first bit ratio between the first parallelized bit stream and the first shaped bit stream, and the second binary shaping operation is associated with a second bit ratio between the second parallelized bit stream and the second shaped bit stream, the first bit ratio and the second bit ratio are fixed.

Aspect 3: The method of any of aspects 1-2, further including: communicating control signaling with the second wireless device, a third wireless device, or both, where the control signaling indicates an MCS, an SE value, or both, associated with communications between the first wireless device and the second wireless device, where a first shaping rate associated with the first binary shaping operation and a second shaping rate associated with the second binary shaping operation are selected in accordance with the MCS, the SE value, or both.

Aspect 4: The method of aspect 3, further including: selecting an overall effective shaping rate in accordance with the MCS, the SE value, or both; and selecting the first shaping rate for the first binary shaping operation and the second shaping rate for the second binary shaping operation in accordance with the overall effective shaping rate, where the first shaping rate is greater than or equal to the second shaping rate.

Aspect 5: The method of any of aspects 3-4, further including: indexing a data object using the MCS, the SE value, or both, to select the first shaping rate and the second shaping rate.

Aspect 6: The method of aspect 5, further including: receiving additional control signaling indicating the data object, where the data object includes mappings between a set of MCSs, a set of SE values, and a set of effective shaping rates, where the data object is indexed in accordance with receiving the additional control signaling.

Aspect 7: The method of any of aspects 1-6, where the first bit position associated with the first parallelized bit stream includes a first amplitude bit position of an I component of each symbol of the message, a Q component of each symbol of the message, or both, and the second bit position associated with the second parallelized bit stream includes a second amplitude bit position of the I component of each symbol of the message, the Q component of each symbol of the message, or both.

Aspect 8: The method of any of aspects 1-7, where the first binary shaping operation and the second binary shaping operation are applied to the first parallelized bit stream and the second parallelized bit stream, respectively, in accordance with linear binary representations of the set of symbols of the modulation constellation, the message is generated in accordance with mapping the linear binary representations of the first shaped bit stream and the second shaped bit stream to Gray coded representations of the set of symbols.

Aspect 9: The method of any of aspects 1-8, further including: applying a third binary shaping operation to a third parallelized bit stream to generate a third shaped bit stream, where the third binary shaping operation is applied in parallel and independently relative to the first binary shaping operation and the second binary shaping operation, where each symbol of the message includes a third bit position associated with the third parallelized bit stream, where the third shaped bit stream is modulated to the set of symbols of the modulation constellation to generate the message.

Aspect 10: The method of aspect 9, where the first binary shaping operation, the second binary shaping operation, and the third binary shaping operation are associated with a first shaping rate, a second shaping rate, and a third shaping rate, respectively, the first shaping rate, the second shaping rate, and the third shaping rate include monotonically decreasing shaping rates.

Aspect 11: The method of any of aspects 1-10, where the first binary shaping operation and the second binary shaping operation are associated with a first shaping rate and a second shaping rate, respectively, the first shaped bit stream and the second shaped bit stream are modulated to the set of symbols of the modulation constellation in accordance with the first shaping rate and the second shaping rate such that a selection frequency of the set of symbols of the modulation constellation is monotonically decreasing relative to an origin of the modulation constellation.

Aspect 12: The method of any of aspects 1-11, further including: selecting an information bit stream for transmission; generating the first parallelized bit stream, the second parallelized bit stream, and a third parallelized bit stream from the information bit stream; and encoding the first shaped bit stream, the second shaped bit stream, and the third parallelized bit stream in accordance with applying the first binary shaping operation and the second binary shaping operation to the first parallelized bit stream and the second parallelized bit stream, respectively, and in accordance with maintaining the third parallelized bit stream as an unshaped bit stream, where the message is generated in accordance with the encoding.

Aspect 13: The method of any of aspects 1-12, where the first binary shaping operation is applied via a first binary encoder component, and the second binary shaping operation is applied via a second binary encoder component.

Aspect 14: The method of aspect 13, where the first binary shaping operation is associated with a target shaping rate, where, to apply the first binary shaping operation, the first binary encoder component is configured to receive an input set of bits from an information bit stream; and generate an output set of bits in accordance with the input set of bits and a mapping function, where a distribution of values of the output set of bits is in accordance with the target shaping rate, and where the first shaped bit stream includes the output set of bits.

Aspect 15: The method of aspect 14, where a ratio between a first quantity of bits of the input set of bits and a second quantity of bits of the output set of bits is in accordance with the target shaping rate.

Aspect 16: The method of any of aspects 1-15, where the first parallelized bit stream is associated with a set of MSB of a set of symbols of the message, and the second parallelized bit stream is associated with a set of LSB of the set of symbols of the message, the first bit position and the second bit position correspond to the set of MSB and the set of LSB, respectively.

Aspect 17: The method of any of aspects 1-16, where the modulation constellation includes a 4 k QAM modulation constellation, a 1 k QAM modulation constellation, a 256 QAM modulation constellation, a 64 QAM modulation constellation, a 16 QAM modulation constellation, or any combination thereof.

Aspect 18: A method for wireless communications at a second wireless device, including: receiving a message from a first wireless device; demodulating the message by mapping a set of symbols of a modulation constellation to at least a first shaped bit stream and a second shaped bit stream; and obtaining a first parallelized bit stream and a second parallelized bit stream of the message in accordance with applying a first binary deshaping operation and a second binary deshaping operation to the first shaped bit stream and the second shaped bit stream, respectively, where the first binary deshaping operation and the second binary deshaping operation are applied independently of one another, where each symbol of the message includes a first bit position associated with the first parallelized bit stream and a second bit position associated with the second parallelized bit stream.

Aspect 19: The method of aspect 18, where the first binary deshaping operation is associated with a first bit ratio between the first parallelized bit stream and the first shaped bit stream, and the second binary deshaping operation is associated with a second bit ratio between the second parallelized bit stream and the second shaped bit stream, the first bit ratio and the second bit ratio are fixed.

Aspect 20: The method of any of aspects 18-19, further including: communicating control signaling with the first wireless device, a third wireless device, or both, where the control signaling indicates an MCS, an SE value, or both, associated with communications between the first wireless device and the second wireless device, where a first shaping rate associated with the first binary deshaping operation and a second shaping rate associated with the second binary deshaping operation are selected in accordance with the MCS, the SE value, or both.

Aspect 21: The method of aspect 20, further including: selecting an overall effective shaping rate in accordance with the MCS, the SE value, or both; and selecting the first shaping rate for the first binary deshaping operation and the second shaping rate for the second binary deshaping operation in accordance with the overall effective shaping rate, where the first shaping rate is greater than or equal to the second shaping rate.

Aspect 22: The method of any of aspects 20-21, further including: indexing a data object using the MCS, the SE value, or both, to select the first shaping rate and the second shaping rate.

Aspect 23: The method of aspect 22, further including: receiving additional control signaling indicating the data object, where the data object includes mappings between a set of MCSs, a set of SE values, and a set of effective shaping rates, where the data object is indexed in accordance with receiving the additional control signaling.

Aspect 24: The method of any of aspects 18-23, where the first binary deshaping operation and the second binary deshaping operation are applied to the first shaped bit stream and the second shaped bit stream, respectively, in accordance with Gray coded binary representations of the set of symbols of the modulation constellation, the first parallelized bit stream and the second parallelized bit stream are obtained in accordance with mapping the Gray coded binary representations to linear binary representations of the first shaped bit stream and the second shaped bit stream.

Aspect 25: The method of any of aspects 18-24, further including: applying a third binary deshaping operation to a third shaped bit stream of the message to generate a third parallelized bit stream, where the third binary deshaping operation is applied in parallel and independently relative to the first binary deshaping operation and the second binary deshaping operation, where each symbol of the message includes a third bit position associated with the third parallelized bit stream.

Aspect 26: The method of aspect 25, where the first binary deshaping operation, the second binary deshaping operation, and the third binary deshaping operation are associated with a first shaping rate, a second shaping rate, and a third shaping rate, respectively, the first shaping rate, the second shaping rate, and the third shaping rate include monotonically decreasing shaping rates.

Aspect 27: The method of any of aspects 18-26, further including: generating the first shaped bit stream, the second shaped bit stream, and a third unshaped bit stream from the message; and decoding the first shaped bit stream, the second shaped bit stream, and the third unshaped bit stream, where the message is processed in accordance with applying the first binary deshaping operation and the second binary deshaping operation to the first shaped bit stream and the second shaped bit stream, respectively.

Aspect 28: The method of any of aspects 18-27, where the first binary deshaping operation is applied via a first binary decoder component, and the second binary deshaping operation is applied via a second binary decoder component.

Aspect 29: The method of any of aspects 18-28, where the first parallelized bit stream is associated with a set of MSB of a set of symbols of the message, and the second parallelized bit stream is associated with a set of LSB of the set of symbols of the message, the first bit position and the second bit position correspond to the set of MSB and the set of LSB, respectively.

Aspect 30: The method of any of aspects 18-29, where the modulation constellation includes a 4 k QAM modulation constellation, a 1 k QAM modulation constellation, a 256 QAM modulation constellation, a 64 QAM modulation constellation, a 16 QAM modulation constellation, or any combination thereof.

Aspect 31: The method of any of aspects 18-30, further including: processing the message in accordance with applying the first binary deshaping operation and the second binary deshaping operation.

Aspect 32: A first wireless device for wireless communications, including one or more memories storing processor-executable code, and one or more processors coupled with the one or more memories and individually or collectively operable to execute the code to cause the first wireless device to perform a method of any of aspects 1-17.

Aspect 33: A first wireless device for wireless communications, including at least one means for performing a method of any of aspects 1 through 17.

Aspect 34: A non-transitory computer-readable medium storing code for wireless communications, the code including instructions executable by one or more processors to perform a method of any of aspects 1 through 17.

Aspect 35: A second wireless device for wireless communications, including one or more memories storing processor-executable code, and one or more processors coupled with the one or more memories and individually or collectively operable to execute the code to cause the second wireless device to perform a method of any of aspects 18 through 31.

Aspect 36: A second wireless device for wireless communications, including at least one means for performing a method of any of aspects 18 through 31.

Aspect 37: A non-transitory computer-readable medium storing code for wireless communications, the code including instructions executable by one or more processors to perform a method of any of aspects 18 through 31.

As used herein, the term “determine” or “determining” encompasses a wide variety of actions and, therefore, “determining” can include calculating, computing, processing, deriving, estimating, investigating, looking up (such as via looking up in a table, a database, or another data structure), inferring, ascertaining, or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing and other such similar actions.

As used herein, a phrase referring to “at least one of” or “one or more of” a list of items refers to any combination of those items, including single members. As an example, “at least one of: a, b, or c” is intended to cover: a, b, c, a-b, a-c, b-c, and a-b-c. As used herein, “or” is intended to be interpreted in the inclusive sense, unless otherwise explicitly indicated. For example, “a or b” may include a only, b only, or a combination of a and b. Furthermore, as used herein, a phrase referring to “a” or “an” element refers to one or more of such elements acting individually or collectively to perform the recited function(s). Additionally, a “set” refers to one or more items, and a “subset” refers to less than a whole set, but non-empty.

As used herein, “based on” is intended to be interpreted in the inclusive sense, unless otherwise explicitly indicated. For example, “based on” may be used interchangeably with “based at least in part on,” “associated with,” “in association with,” or “in accordance with” unless otherwise explicitly indicated. Specifically, unless a phrase refers to “based on only ‘a,’” or the equivalent in context, whatever it is that is “based on ‘a,’” or “based at least in part on ‘a,’” may be based on “a” alone or based on a combination of “a” and one or more other factors, conditions, or information.

The various illustrative components, logic, logical blocks, modules, circuits, operations, and algorithm processes described in connection with the examples disclosed herein may be implemented as electronic hardware, firmware, software, or combinations of hardware, firmware, or software, including the structures disclosed in this specification and the structural equivalents thereof. The interchangeability of hardware, firmware and software has been described generally, in terms of functionality, and illustrated in the various illustrative components, blocks, modules, circuits and processes described above. Whether such functionality is implemented in hardware, firmware or software depends upon the particular application and design constraints imposed on the overall system.

Various modifications to the examples described in this disclosure may be readily apparent to a person having ordinary skill in the art, and the generic principles defined herein may be applied to other examples without departing from the spirit or scope of this disclosure. Thus, the claims are not intended to be limited to the examples shown herein, but are to be accorded the widest scope consistent with this disclosure, the principles and the novel features disclosed herein.

Additionally, various features that are described in this specification in the context of separate examples also can be implemented in combination in a single implementation. Conversely, various features that are described in the context of a single implementation also can be implemented in multiple examples separately or in any suitable subcombination. As such, although features may be described above as acting in particular combinations, and even initially claimed as such, one or more features from a claimed combination can in some implementations be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flowchart or flow diagram. However, other operations that are not depicted can be incorporated in the example processes that are schematically illustrated. For example, one or more additional operations can be performed before, after, simultaneously, or between any of the illustrated operations. In some circumstances, multitasking and parallel processing may be advantageous. Moreover, the separation of various system components in the examples described above should not be understood as requiring such separation in all examples, and it should be understood that the described program components and systems can generally be integrated together in a single software product or packaged into multiple software products.

1. A first wireless device, comprising:
a processing system that includes processor circuitry and memory circuitry that stores code, the processing system configured to cause the first wireless device to:
obtain a first shaped bit stream and a second shaped bit stream in accordance with applying a first binary shaping operation and a second binary shaping operation to a first parallelized bit stream and a second parallelized bit stream, respectively,
wherein the first binary shaping operation and the second binary shaping operation are applied independently of one another,
wherein each symbol of a message to be transmitted by the first wireless device includes a first bit position associated with the first parallelized bit stream and a second bit position associated with the second parallelized bit stream;
generate the message in accordance with modulating the first shaped bit stream and the second shaped bit stream to a set of symbols of a modulation constellation; and
transmit the message to a second wireless device.

2. The first wireless device of claim 1, wherein the first binary shaping operation is associated with a first bit ratio between the first parallelized bit stream and the first shaped bit stream, and wherein the second binary shaping operation is associated with a second bit ratio between the second parallelized bit stream and the second shaped bit stream, wherein the first bit ratio and the second bit ratio are fixed.

3. The first wireless device of claim 1, wherein the processing system is further configured to cause the first wireless device to:
communicate control signaling with the second wireless device, a third wireless device, or both, wherein the control signaling indicates a modulation and coding scheme, a spectral efficiency value, or both, associated with communications between the first wireless device and the second wireless device, wherein a first shaping rate associated with the first binary shaping operation and a second shaping rate associated with the second binary shaping operation are selected in accordance with the modulation and coding scheme, the spectral efficiency value, or both.

4. The first wireless device of claim 3, wherein the processing system is further configured to cause the first wireless device to:
select an overall effective shaping rate in accordance with the modulation and coding scheme, the spectral efficiency value, or both; and
select the first shaping rate for the first binary shaping operation and the second shaping rate for the second binary shaping operation in accordance with the overall effective shaping rate, wherein the first shaping rate is greater than or equal to the second shaping rate.

5. (canceled)

6. (canceled)

7. The first wireless device of claim 1, wherein the first bit position associated with the first parallelized bit stream includes a first amplitude bit position of an I component of each symbol of the message, a Q component of each symbol of the message, or both, and wherein the second bit position associated with the second parallelized bit stream includes a second amplitude bit position of the I component of each symbol of the message, the Q component of each symbol of the message, or both.

8. The first wireless device of claim 1, wherein the first binary shaping operation and the second binary shaping operation are applied to the first parallelized bit stream and the second parallelized bit stream, respectively, in accordance with linear binary representations of the set of symbols of the modulation constellation, wherein the message is generated in accordance with mapping the linear binary representations of the first shaped bit stream and the second shaped bit stream to Gray coded representations of the set of symbols.

9. The first wireless device of claim 1, wherein the processing system is further configured to cause the first wireless device to:
apply a third binary shaping operation to a third parallelized bit stream to generate a third shaped bit stream, wherein the third binary shaping operation is applied in parallel and independently relative to the first binary shaping operation and the second binary shaping operation, wherein each symbol of the message includes a third bit position associated with the third parallelized bit stream, wherein the third shaped bit stream is modulated to the set of symbols of the modulation constellation to generate the message.

10. (canceled)

11. The first wireless device of claim 1, wherein the first binary shaping operation and the second binary shaping operation are associated with a first shaping rate and a second shaping rate, respectively, wherein the first shaped bit stream and the second shaped bit stream are modulated to the set of symbols of the modulation constellation in accordance with the first shaping rate and the second shaping rate such that a selection frequency of the set of symbols of the modulation constellation is monotonically decreasing relative to an origin of the modulation constellation.

12. The first wireless device of claim 1, wherein the processing system is further configured to cause the first wireless device to:
select an information bit stream for transmission;
generate the first parallelized bit stream, the second parallelized bit stream, and a third parallelized bit stream from the information bit stream; and
encode the first shaped bit stream, the second shaped bit stream, and the third parallelized bit stream in accordance with applying the first binary shaping operation and the second binary shaping operation to the first parallelized bit stream and the second parallelized bit stream, respectively, and in accordance with maintaining the third parallelized bit stream as an unshaped bit stream, wherein the message is generated in accordance with the encoding.

13. The first wireless device of claim 1, wherein the first binary shaping operation is applied via a first binary encoder component, and wherein the second binary shaping operation is applied via a second binary encoder component.

14. The first wireless device of claim 13, wherein the first binary shaping operation is associated with a target shaping rate, wherein, to apply the first binary shaping operation, the processing system is further configured to cause the first binary encoder component is configured to:
receive an input set of bits from an information bit stream; and
generate an output set of bits in accordance with the input set of bits and a mapping function, wherein a distribution of values of the output set of bits is in accordance with the target shaping rate, and wherein the first shaped bit stream comprises the output set of bits.

15. (canceled)

16. The first wireless device of claim 1, wherein the first parallelized bit stream is associated with a plurality of most significant bits of a plurality of symbols of the message, and wherein the second parallelized bit stream is associated with a plurality of least significant bits of the plurality of symbols of the message, wherein the first bit position and the second bit position correspond to the plurality of most significant bits and the plurality of least significant bits, respectively.

17. (canceled)

18. A second wireless device, comprising:
a processing system that includes processor circuitry and memory circuitry that stores code, the processing system configured to cause the second wireless device to:
receive a message from a first wireless device;
demodulate the message by mapping a set of symbols of a modulation constellation to at least a first shaped bit stream and a second shaped bit stream; and
obtain a first parallelized bit stream and a second parallelized bit stream of the message in accordance with applying a first binary deshaping operation and a second binary deshaping operation to the first shaped bit stream and the second shaped bit stream, respectively,
wherein the first binary deshaping operation and the second binary deshaping operation are applied independently of one another,
wherein each symbol of the message includes a first bit position associated with the first parallelized bit stream and a second bit position associated with the second parallelized bit stream.

19. The second wireless device of claim 18, wherein the first binary deshaping operation is associated with a first bit ratio between the first parallelized bit stream and the first shaped bit stream, and wherein the second binary deshaping operation is associated with a second bit ratio between the second parallelized bit stream and the second shaped bit stream, wherein the first bit ratio and the second bit ratio are fixed.

20. The second wireless device of claim 18, wherein the processing system is further configured to cause the second wireless device to:
communicate control signaling with the first wireless device, a third wireless device, or both, wherein the control signaling indicates a modulation and coding scheme, a spectral efficiency value, or both, associated with communications between the first wireless device and the second wireless device, wherein a first shaping rate associated with the first binary deshaping operation and a second shaping rate associated with the second binary deshaping operation are selected in accordance with the modulation and coding scheme, the spectral efficiency value, or both.

21. The second wireless device of claim 20, wherein the processing system is further configured to cause the second wireless device to:
select an overall effective shaping rate in accordance with the modulation and coding scheme, the spectral efficiency value, or both; and
select the first shaping rate for the first binary deshaping operation and the second shaping rate for the second binary deshaping operation in accordance with the overall effective shaping rate, wherein the first shaping rate is greater than or equal to the second shaping rate.

22. (canceled)

23. (canceled)

24. The second wireless device of claim 18, wherein the first binary deshaping operation and the second binary deshaping operation are applied to the first shaped bit stream and the second shaped bit stream, respectively, in accordance with Gray coded binary representations of the set of symbols of the modulation constellation, wherein the first parallelized bit stream and the second parallelized bit stream are obtained in accordance with mapping the Gray coded binary representations to linear binary representations of the first shaped bit stream and the second shaped bit stream.

25. The second wireless device of claim 18, wherein the processing system is further configured to cause the second wireless device to:
apply a third binary deshaping operation to a third shaped bit stream of the message to generate a third parallelized bit stream, wherein the third binary deshaping operation is applied in parallel and independently relative to the first binary deshaping operation and the second binary deshaping operation, wherein each symbol of the message includes a third bit position associated with the third parallelized bit stream.

26. (canceled)

27. The second wireless device of claim 18, wherein the processing system is further configured to cause the second wireless device to:
generate the first shaped bit stream, the second shaped bit stream, and a third unshaped bit stream from the message; and
decode the first shaped bit stream, the second shaped bit stream, and the third unshaped bit stream, wherein the message is processed in accordance with applying the first binary deshaping operation and the second binary deshaping operation to the first shaped bit stream and the second shaped bit stream, respectively.

28. (canceled)

29. The second wireless device of claim 18, wherein the first parallelized bit stream is associated with a plurality of most significant bits of a plurality of symbols of the message, and wherein the second parallelized bit stream is associated with a plurality of least significant bits of the plurality of symbols of the message, wherein the first bit position and the second bit position correspond to the plurality of most significant bits and the plurality of least significant bits, respectively.

30. (canceled)

31. (canceled)

32. A method for wireless communications at a first wireless device, comprising:
obtaining a first shaped bit stream and a second shaped bit stream in accordance with applying a first binary shaping operation and a second binary shaping operation to a first parallelized bit stream and a second parallelized bit stream, respectively, wherein the first binary shaping operation and the second binary shaping operation are applied independently of one another, wherein each symbol of a message to be transmitted by the first wireless device includes a first bit position associated with the first parallelized bit stream and a second bit position associated with the second parallelized bit stream;
generating the message in accordance with modulating the first shaped bit stream and the second shaped bit stream to a set of symbols of a modulation constellation; and
transmitting the message to a second wireless device.

33. The method of claim 32, further comprising:
communicating control signaling with the second wireless device, a third wireless device, or both, wherein the control signaling indicates a modulation and coding scheme, a spectral efficiency value, or both, associated with communications between the first wireless device and the second wireless device, wherein a first shaping rate associated with the first binary shaping operation and a second shaping rate associated with the second binary shaping operation are selected in accordance with the modulation and coding scheme, the spectral efficiency value, or both.

34. The method of claim 33, further comprising:
selecting an overall effective shaping rate in accordance with the modulation and coding scheme, the spectral efficiency value, or both; and
selecting the first shaping rate for the first binary shaping operation and the second shaping rate for the second binary shaping operation in accordance with the overall effective shaping rate, herein the first shaping rate is greater than or equal to the second shaping rate.

35. The method of claim 33, further comprising:
applying a third binary shaping operation to a third parallelized bit stream to generate a third shaped bit stream, wherein the third binary shaping operation is applied in parallel and independently relative to the first binary shaping operation and the second binary shaping operation, wherein each symbol of the message includes a third bit position associated with the third parallelized bit stream, wherein the third shaped bit stream is modulated to the set of symbols of the modulation constellation to generate the message.

36. The method of claim 35, wherein the first binary shaping operation, the second binary shaping operation, and the third binary shaping operation are associated with a first shaping rate, a second shaping rate, and a third shaping rate, respectively, wherein the first shaping rate, the second shaping rate, and the third shaping rate include monotonically decreasing shaping rates.

37. A method for wireless communications at a second wireless device, comprising:
receiving a message from a first wireless device;
demodulating the message by mapping a set of symbols of a modulation constellation to at least a first shaped bit stream and a second shaped bit stream; and
obtaining a first parallelized bit stream and a second parallelized bit stream of the message in accordance with applying a first binary deshaping operation and a second binary deshaping operation to the first shaped bit stream and the second shaped bit stream, respectively, wherein the first binary deshaping operation and the second binary deshaping operation are applied independently of one another, wherein each symbol of the message includes a first bit position associated with the first parallelized bit stream and a second bit position associated with the second parallelized bit stream.

38. The method of claim 37, further comprising:
communicating control signaling with the first wireless device, a third wireless device, or both, wherein the control signaling indicates a modulation and coding scheme, a spectral efficiency value, or both, associated with communications between the first wireless device and the second wireless device, wherein a first shaping rate associated with the first binary deshaping operation and a second shaping rate associated with the second binary deshaping operation are selected in accordance with the modulation and coding scheme, the spectral efficiency value, or both.

39. The method of claim 38, further comprising:
indexing a data object using the modulation and coding scheme, the spectral efficiency value, or both, to select the first shaping rate and the second shaping rate.

40. The method of claim 37, wherein the first binary deshaping operation is applied via a first binary decoder component, and wherein the second binary deshaping operation is applied via a second binary decoder component.

41. The method of claim 37, wherein the first parallelized bit stream is associated with a plurality of most significant bits of a plurality of symbols of the message, and wherein the second parallelized bit stream is associated with a plurality of least significant bits of the plurality of symbols of the message, wherein the first bit position and the second bit position correspond to the plurality of most significant bits and the plurality of least significant bits, respectively.
